(19) United States
(12) Patent Application Publication
(10) Pub. No.: US 2015/0200751 A1
(43) Pub. Date: Jul. 16, 2015

(54) ENHANCED PUCCH REPORTING FOR CARRIER AGGREGATION

(71) Applicant: Sharp Laboratories of America, Inc., Camas, WA (US)

(72) Inventors: Zhanping Yin, Vancouver, WA (US); Shohei Yamada, Camas, WA (US)

(73) Assignee: Sharp Laboratories of America, Inc., Camas, WA (US)

(21) Appl. No.: 14/152,362

(22) Filed: Jan. 10, 2014

(51) Int. Cl. H04L 1/18; H04L 5/14

(52) U.S. Cl. CPC H04L 1/1887; H04L 5/14; H04W 72/0446

(57) ABSTRACT

A User Equipment (UE) for performing carrier aggregation is described. The UE includes a processor and instructions stored in memory that is in electronic communication with the processor. Multiple serving cells are configured. The UE determines a first parameter that defines a maximum number of elements with downlink (DL) assignments for a subframe in the DL association set for a serving cell. The UE determines physical downlink shared channel (PDSCH) hybrid automatic repeat request acknowledgement/negative acknowledgement (HARQ-ACK) information for the serving cell according to the first parameter. The UE sends the PDSCH HARQ-ACK information.

### TECHNICAL FIELD

The present disclosure relates generally to communication systems. More specifically, the present disclosure relates to enhanced physical uplink control channel (PUCCH) reporting for carrier aggregation.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one configuration of one or more evolved Node Bs (eNBs) and one or more user equipments (UEs) in which systems and methods for carrier aggregation may be implemented;

FIG. 2 is a flow diagram illustrating one implementation of a method for performing carrier aggregation by a UE;

FIG. 3 is a flow diagram illustrating one implementation of a method for performing carrier aggregation by an eNB;

FIG. 4 is a diagram illustrating one example of a radio frame that may be used in accordance with the systems and methods disclosed herein;

FIG. 5 is a diagram illustrating some time-division duplexing (TDD) uplink-downlink (UL/DL) configurations in accordance with the systems and methods described herein;

FIG. 6 illustrates the association timings of a frequency-division duplexing (FDD) cell;

FIG. 7 is a flow diagram illustrating a detailed configuration of a method for performing carrier aggregation by a UE;

FIG. 8 is a flow diagram illustrating another detailed configuration of a method for performing carrier aggregation by a UE;

FIG. 9 illustrates one configuration of association timings of a TDD primary cell (PCell) and a FDD secondary cell (SCell);

FIG. 10 illustrates another configuration of association timings of a TDD PCell and a FDD SCell;

FIG. 11 illustrates various components that may be utilized in a UE;

FIG. 12 illustrates various components that may be utilized in an eNB;

FIG. 13 is a block diagram illustrating one configuration of a UE in which systems and methods for performing carrier aggregation may be implemented; and

FIG. 14 is a block diagram illustrating one configuration of an eNB in which systems and methods for performing carrier aggregation may be implemented.

### DETAILED DESCRIPTION

A user equipment (UE) for performing carrier aggregation is described. The UE includes a processor and memory in electronic communication with the processor. Executable instructions are stored in the memory. Multiple serving cells are configured. The UE determines a first parameter that defines a maximum number of elements with downlink (DL) assignments for a subframe in the DL association set for a serving cell. The UE determines physical downlink shared channel (PDSCH) hybrid automatic repeat request acknowledgement/negative acknowledgement (HARQ-ACK) information for the serving cell according to the first parameter. The UE sends the PDSCH HARQ-ACK information.

The UE may receive the first parameter via higher layer signaling from an evolved Node B (eNB). The first parameter may be pre-defined as 4. If the UE is configured with physical uplink control channel (PUCCH) format 1b with channel selection, the first parameter may be assumed to be set. Determining the PDSCH HARQ-ACK information for the serving cell according to the first parameter may include determining a number of HARQ-ACK bits for the serving cell according to the first parameter.

The UE may be configured with PUCCH format 1b with channel selection. The UE may send the PDSCH HARQ-ACK information using PUCCH format 1b with channel selection. The number of elements for the subframe of the DL association set in the serving cell may equal max (M_{primary}, min(M_{secondary}, M_{config})). M_{primary} is the number of elements for the subframe of the DL association set in a primary cell. M_{secondary} is the number of elements for the subframe of the DL association set in a secondary cell. M_{config} is the first parameter.

The primary cell may be a TDD cell with a DL-reference UL/DL configuration belonging to a TDD UL/DL configuration in the set of {0, 1, 2, 3, 4, 6}. The secondary cell may be a FDD cell.

Every serving cell may be a TDD cell. A DL-reference UL/DL configuration of the primary cell may belong to a TDD UL/DL configuration in the set of {0,1,2,3,4,6}. A DL-reference UL/DL configuration of the secondary cell may belong to a TDD UL/DL configuration 5.

The UE may be configured with PUCCH format 3. The UE may generate the PDSCH HARQ-ACK information for the serving cell based on the minimum number between the number of elements with DL assignments for the subframe in the DL association set for the serving cell and the first parameter. The UE may send the PDSCH HARQ-ACK information using PUCCH format 3.

In one configuration, a primary cell may be a TDD cell and a secondary cell may be a FDD cell. In another configuration, every serving cell may be a TDD cell. A DL-reference UL/DL configuration of a primary cell may belong to a TDD UL/DL configuration in the set of {0,1,2,3,4,6}.

An evolved Node B (eNB) for performing carrier aggregation is also described. The eNB includes a processor and memory in electronic communication with the processor. Executable instructions are stored in the memory. Multiple serving cells are configured. The eNB determines a first parameter that defines a maximum number of elements with DL assignments for a subframe in the DL association set for a serving cell. The eNB receives PDSCH HARQ-ACK information for the serving cell. The PDSCH HARQ-ACK information is determined according to the first parameter.

The eNB may send the first parameter via higher layer signaling to a UE. The first parameter may be pre-defined as 4. If a UE is configured with physical uplink control channel (PUCCH) format 1b with channel selection, the first parameter may be assumed to be set. Determining the PDSCH HARQ-ACK information for the serving cell may include determining a number of HARQ-ACK bits for the serving cell according to the first parameter.

The eNB may also configure a UE with PUCCH format 1b with channel selection. The eNB may further receive the PDSCH HARQ-ACK information using PUCCH format 1b with channel selection. The number of elements for the subframe of the DL association set in the serving cell may equal max(M_{primary}, min(M_{secondary}, M_{config})). M_{primary} is the number of elements for the subframe of the DL association set in a primary cell. M_{secondary} is the number of elements for the subframe of the DL association set in a secondary cell. M_{config} is the first parameter.

The primary cell may be a TDD cell with a DL-reference UL/DL configuration belonging to a TDD UL/DL configuration in the set of {0,1,2,3,4,6}. The secondary cell may be a FDD cell.

Every serving cell may be a TDD cell, a DL-reference UL/DL configuration of the primary cell may belong to a TDD UL/DL configuration in the set of {0,1,2,3,4,6}. A DL-reference UL/DL configuration of the secondary cell may belong to a TDD UL/DL configuration 5.

The eNB may also configure a UE with PUCCH format 3. The eNB may further receive the PDSCH HARQ-ACK information using PUCCH format 3. The PDSCH HARQ-ACK information may be generated based on the minimum number between the number of elements with DL assignments for the subframe in the DL association set for the serving cell and the first parameter.

In one configuration, a primary cell may be a TDD cell and a secondary cell may be a FDD cell. In another configuration, every serving cell may be a TDD cell. A DL-reference UL/DL configuration of a primary cell may belong to a TDD UL/DL configuration in the set of {0,1,2,3,4,6}.

A method for performing carrier aggregation by a UE is also described. The method includes determining a first parameter that defines a maximum number of elements with DL assignments for a subframe in the DL association set for a serving cell. Multiple serving cells are configured. The method also includes determining PDSCH HARQ-ACK information for the serving cell according to the first parameter. The method further includes sending the PDSCH HARQ-ACK information.

A method for performing carrier aggregation by an eNB is also described. The method includes determining a first parameter that defines a maximum number of elements with DL assignments for a subframe in the DL association set for a serving cell. Multiple serving cells are configured. The method also includes receiving PDSCH HARQ-ACK information for the serving cell. The PDSCH HARQ-ACK information is determined according to the first parameter.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an eNB, a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

When carrier aggregation (CA) is configured, the UE may have one radio resource control (RRC) connection with the network. One radio interface may provide carrier aggregation. During RRC connection establishment, re-establishment and handover, one serving cell may provide non-access stratum (NAS) mobility information (e.g., a tracking area identity (TAI)). During RRC connection re-establishment and handover, one serving cell may provide a security input. This cell may be referred to as the primary cell (PCell). In the downlink, the component carrier corresponding to the PCell may be the downlink primary component carrier (DL PCC), while in the uplink it may be the uplink primary component carrier (UL PCC).

Depending on UE capabilities, one or more SCells may be configured to form together with the PCell a set of serving cells. In the downlink, the component carrier corresponding to a SCell may be a downlink secondary component carrier (DL SCC), while in the uplink it may be an uplink secondary component carrier (UL SCC).

The configured set of serving cells for the UE, therefore, may consist of one PCell and one or more SCells. For each SCell, the usage of uplink resources by the UE (in addition to the downlink resources) may be configurable. The number of DL SCCs configured may be larger than or equal to the number of UL SCCs and no SCell may be configured for usage of uplink resources only.

From a UE viewpoint, each uplink resource may belong to one serving cell. The number of serving cells that may be configured depends on the aggregation capability of the UE. The PCell may only be changed using a handover procedure (e.g., with a security key change and a random access channel (RACH) procedure). The PCell may be used for transmission of the PUCCH. Unlike the SCells, the PCell may not be deactivated. Re-establishment may be triggered when the PCell experiences radio link failure (RLF), not when the SCells experience RLF. Furthermore, NAS information may be taken from the PCell.

The reconfiguration, addition and removal of SCells may be performed by an RRC. At intra-LTE handover, RRC may also add, remove or reconfigure SCells for usage with a target PCell. When adding a new SCell, dedicated RRC signaling may be used for sending all required system information of the SCell (e.g., while in connected mode, UEs need not acquire broadcasted system information directly from the SCells).

The systems and methods disclosed herein describe carrier aggregation. In some implementations, the systems and methods disclosed herein describe LTE enhanced carrier aggregation (eCA) with hybrid duplexing. In particular, the systems and methods describe downlink (DL) association sets and PDSCH hybrid automatic repeat request acknowledgement/negative acknowledgement (HARQ-ACK) transmission timings that may be used in time division duplexing (TDD) and frequency division duplexing (FDD) carrier aggregation (CA). In one case, a primary cell (PCell) may report uplink control information (UCI). In another case, a secondary cell (SCell) may be configured as a reporting cell for the UCI.

Carrier aggregation refers to the concurrent utilization of more than one carrier. In carrier aggregation, more than one cell may be aggregated to a UE. In one example, carrier aggregation may be used to increase the effective bandwidth available to a UE. The same TDD uplink-downlink (UL/DL) configuration has to be used for TDD CA in Release-10, and for intra-band CA in Release-11. In Release-11, inter-band TDD CA with different TDD UL/DL configurations is supported. The inter-band TDD CA with different TDD UL/DL configurations may provide the flexibility of a TDD network in CA deployment. Furthermore, enhanced interference management with traffic adaptation (eIMTA) (also referred to as dynamic UL/DL reconfiguration) may allow flexible TDD UL/DL reconfiguration based on the network traffic load.

It should be noted that the term “concurrent” and variations thereof as used herein may denote that two or more events may overlap each other in time and/or may occur near in time to each other. Additionally, “concurrent” and variations thereof may or may not mean that two or more events occur at precisely the same time.

A FDD cell requires spectrum (e.g., radio communication frequencies or channels) in which contiguous subsets of the spectrum are entirely allocated to either UL or DL but not both. Accordingly, FDD may have carrier frequencies that are paired (e.g., paired DL and UL carrier frequencies). However, TDD does not require paired channels. Instead, TDD may allocate UL and DL resources on the same carrier frequency. Therefore, TDD may provide more flexibility on spectrum usage. With the increase in wireless network traffic, and as spectrum resources become very precious, new allocated spectrum tends to be fragmented and has smaller bandwidth, which is more suitable for TDD and/or small cell deployment. Furthermore, TDD may provide flexible channel usage through traffic adaptation with different TDD UL/DL configurations and dynamic UL/DL re-configuration.

In carrier aggregation, the HARQ-ACK bits of all configured cells can be reported on the physical uplink control channel (PUCCH) of the PCell, or on a physical uplink shared channel (PUSCH). In 3GPP Release-10 and 11, CA for FDD cells and CA for TDD cells with the same or different UL/DL configurations are specified. Support for carrier aggregation between TDD and FDD cells (e.g., TDD-FDD CA) was introduced in 3GPP Release-12. TDD and FDD cells have very different HARQ-ACK reporting mechanisms. The systems and methods described herein provide for enhanced PUCCH reporting for TDD-FDD CA and TDD CA.

Currently, for TDD, if a UE is configured with more than one serving cell, PUCCH format 1b with channel selection is not supported if configuration 5 is configured in any cell or is used as the DL-reference UL/DL configuration of a serving cell. This limits the usage of channel selection in some uplink subframes where the number of ACK/NACK bits is very small. For a serving cell with DL-reference UL/DL configuration as UL/DL configuration 5, PUCCH format 3 has to be configured, and the ACK/NACK bits of all DL or special subframes are generated and reported on PUCCH. This causes a very big payload on the PUCCH format 3. Consequently, only two serving cells can be supported if UL/DL configuration 5 is used in TDD CA with the same or different UL/DL configurations.

TDD can be represented by a frame structure type 2, while FDD can be represented by a frame structure type 1. A UE that supports aggregating more than one serving cell with frame structure type 2 is configured by higher layers to use either PUCCH format 1b with channel selection or PUCCH format 3 for transmission of HARQ-ACK when configured with more than one serving cell with frame structure type 2.

A UE that supports aggregating more than one serving cell with frame structure type 2 is configured by higher layers to use HARQ-ACK bundling, PUCCH format 1b with channel selection, or PUCCH format 3 for transmission of HARQ-ACK when configured with one serving cell with frame structure type 2. PUCCH format 1b with channel selection is currently not supported for TDD UL/DL configuration 5.

For TDD-FDD CA, two options may be used for the HARQ-ACK timing in the case when the PCell is a TDD cell and the SCell is a FDD cell. In the first option for TDD-FDD CA, a DL association set is defined for the FDD cell so that the HARQ-ACK of DL association sets is reported to a subset or all uplink subframes of the TDD PCell. With this first option, in some cases (e.g. if the FDD SCell is mapped with UL/DL configuration 2 or UL/DL configuration 4), the DL association set may have 5 DL subframes. Therefore, existing channel selection methods that support up to 4 subframes in a DL association set cannot be used directly.

In the second option for TDD-FDD CA, a DL-reference UL/DL configuration is configured by radio resource control (RRC) signaling. In this option, the existing TDD CA with the same or different UL/DL configurations may be reused. With this option, the DL subframes indicated as UL in the DL-reference UL/DL configuration of the FDD SCell cannot be used for any PDSCH transmission for TDD-FDD CA UEs. To maximize the potential DL subframes that can be used for a TDD-FDD CA UE, a UL/DL configuration with a maximum DL allocation should be used. However, according to known solutions, if the FDD SCell is configured with UL/DL configuration 5, channel selection cannot be used regardless of the PCell TDD UL/DL configuration. Furthermore, use of UL/DL configuration 5 further limits the number of aggregated cells. For example, only 2 cells can be aggregated if a FDD SCell is configured with UL/DL configuration 5 as the DL-reference UL/DL configuration.

In both options, there are issues with support of PUCCH format 1b with channel selection on a FDD SCell if the number of DL subframes in a set is greater than 4. Furthermore, the payload in PUCCH format 3 tends to be large, which may reduce the maximum number of supported cells.

The systems and methods described herein provide for HARQ-ACK multiplexing and reporting when the number of DL subframes in a DL association set is greater than 4. In one configuration, PUCCH format 1b with channel selection may be utilized when the number of DL subframes in a DL association set is greater than 4. In another configuration, if PUCCH format 3 is configured, the ACK/NACK of all DL or special subframes in the DL association set has to be reported on PUCCH format 3. With the introduction of the maximum number of assigned DL subframes, the ACK/NACK bits in a HARQ-ACK report on PUCCH format 3 can also be reduced.

The systems and methods disclosed herein may provide the following benefits. CA in a hybrid duplexing network that includes FDD and TDD cells may operate seamlessly. The use and scheduling of DL subframes may be more flexible. Resource use may be flexible when both FDD and TDD are used by a UE. The HARQ-ACK payload may be reduced. Channel selection may be supported even if UL/DL configuration 5 is used as a reference configuration. Additionally, up to five cells may be supported even when UL/DL configuration 5 is used as a reference configuration.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

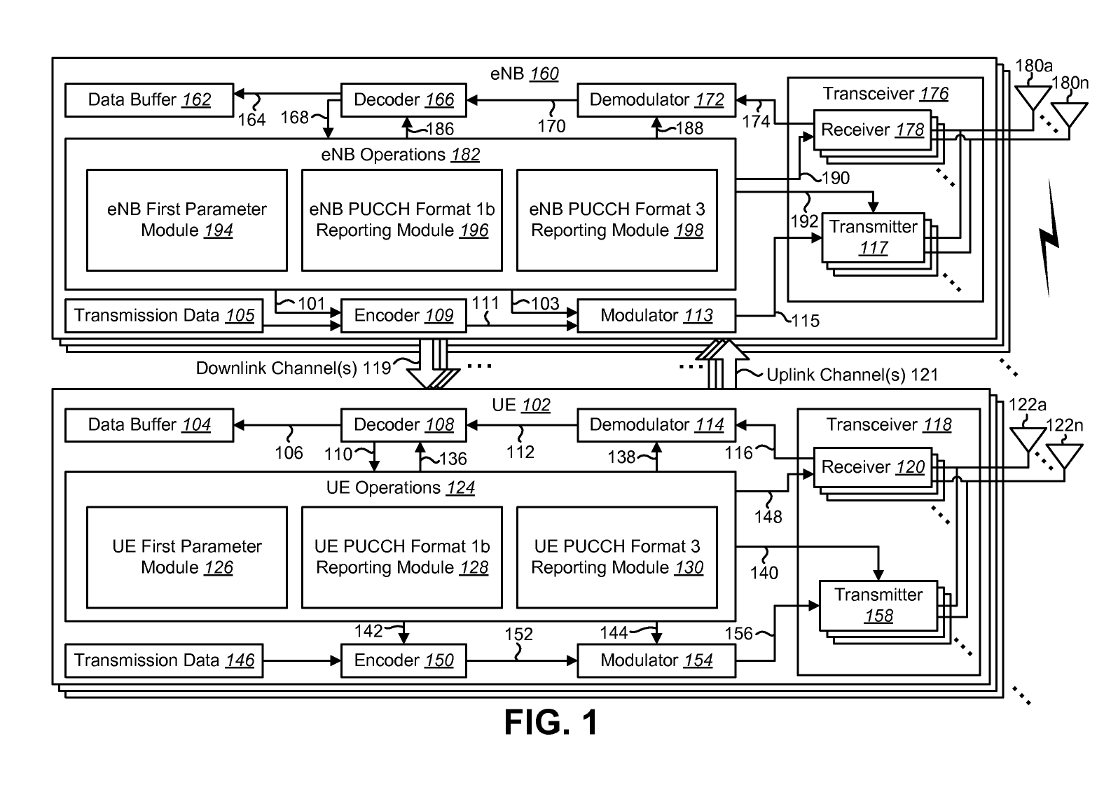

FIG. 1 is a block diagram illustrating one configuration of one or more evolved Node Bs (eNBs) 160 and one or more user equipments (UEs) 102 in which systems and methods for carrier aggregation may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

It should be noted that in some configurations, one or more of the UEs 102 described herein may be implemented in a single device. For example, multiple UEs 102 may be combined into a single device in some implementations. Additionally or alternatively, in some configurations, one or more of the eNBs 160 described herein may be implemented in a single device. For example, multiple eNBs 160 may be combined into a single device in some implementations. In the context of FIG. 1, for instance, a single device may include one or more UEs 102 in accordance with the systems and methods described herein. Additionally or alternatively, one or more eNBs 160 in accordance with the systems and methods described herein may be implemented as a single device or multiple devices.

The UE 102 and the eNB 160 may use one or more channels 119, 121 to communicate with each other. For example, a UE 102 may transmit information or data to the eNB 160 using one or more uplink channels 121 and signals. Examples of uplink channels 121 include a PUCCH and a PUSCH, etc. Examples of uplink signals include a demodulation reference signal (DMRS) and a sounding reference signal (SRS), etc. The one or more eNBs 160 may also transmit information or data to the one or more UEs 102 using one or more downlink channels 119 and signals, for instance. Examples of downlink channels 119 include a PDCCH, a PDSCH, etc. Examples of downlink signals include a primary synchronization signal (PSS), a cell-specific reference signal (CRS), and a channel state information (CSI) reference signal (CSI-RS), etc. Other kinds of channels or signals may be used.

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include one or more of a UE first parameter module 126, a UE PUCCH format 1b reporting module 128 and a UE PUCCH format 3 reporting module 130.

The UE first parameter module 126 may determine a first parameter that defines a maximum number of elements with downlink (DL) assignments for a subframe in the DL association set for a serving cell. Multiple serving cells may be configured for carrier aggregation. In one configuration, a PCell may be a TDD cell and an SCell may be a FDD cell (e.g., TDD-FDD CA). In another configuration, each cell may be a TDD cell (e.g., TDD CA). The first parameter may be referred to as M_{config}.

In one configuration, the first parameter may be a fixed value. For example, the first parameter may be pre-defined as 4. In another configuration, the first parameter may be configured by higher layer signaling (e.g., RRC signaling) from the eNB 160. In other words, the UE 102 may be configured to limit the maximum number of elements with DL assignments for subframe n in the DL association set K by a higher layer signaling. In yet another configuration, the first parameter may be based on a DL-reference UL/DL configuration or the PCell UL/DL configuration.

In one configuration, the first parameter may be cell-specific. In another configuration, the first parameter may be UE-specific.

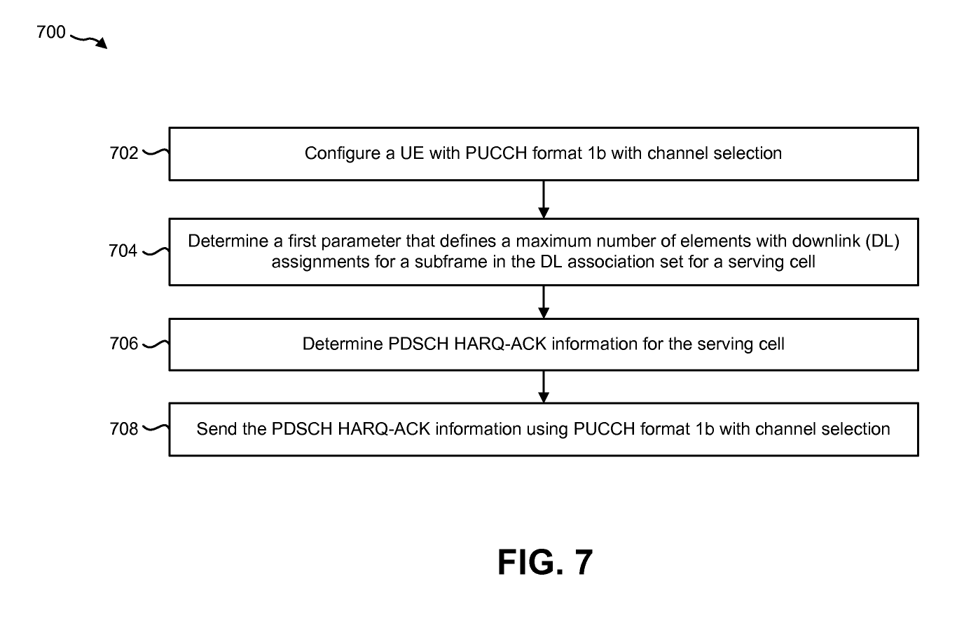

If the UE 102 is configured with PUCCH format 1b with channel selection, the UE PUCCH format 1b reporting module 128 may send PDSCH HARQ-ACK information based on the first parameter using PUCCH format 1b with channel selection. If PUCCH format 1b with channel selection is configured, the UE PUCCH format 1b reporting module 128 may assume that the first parameter is configured. The UE PUCCH format 1b reporting module 128 may determine the number of HARQ-ACK bits for a serving cell according to the first parameter. This may be accomplished as described in connection with FIG. 7.

If a DL association set has more than 4 subframes, and if 4 or less DL or special subframes are assigned to the UE 102, PUCCH format 1b with channel selection can be supported. Furthermore, the channel selection table for TDD CA in Release-10, 11, or 12 can be reused. In one configuration, the UE 102 may be configured with the first parameter for a FDD SCell to support PUCCH format 1b with channel selection.

The UE PUCCH format 1b reporting module 128 may monitor the DL downlink assignment index (DAI) filed in downlink control information (DCI) to determine the ordering and multiplexing of the HARQ-ACK bits. If the received maximum DL DAI is less than the first parameter, the remaining HARQ-ACK bits may be set to discontinuous transmission (DTX).

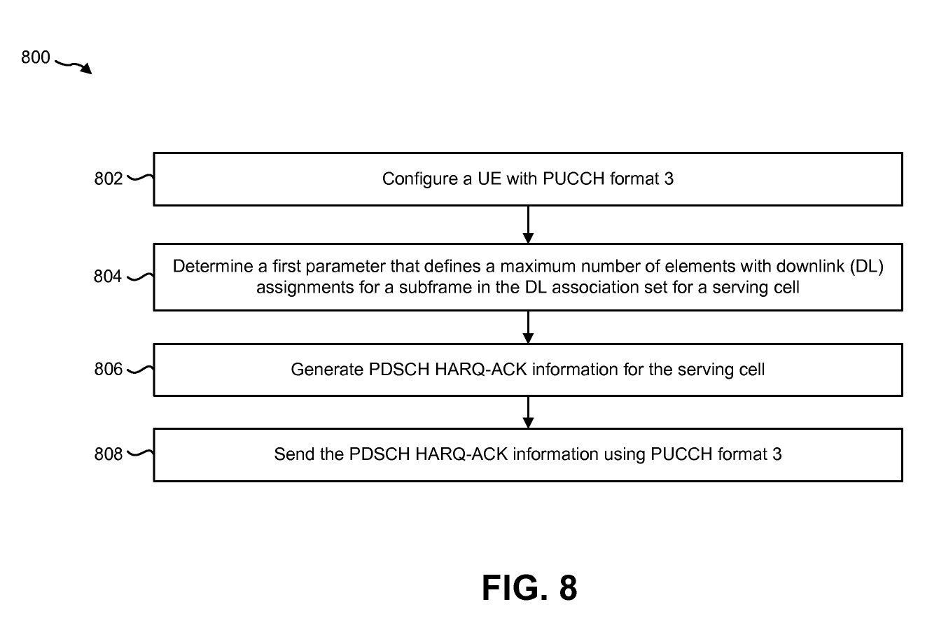

If the UE 102 is configured with PUCCH format 3, the UE PUCCH format 3 reporting module 130 may send PDSCH HARQ-ACK information based on the first parameter using PUCCH format 3. For a serving cell configured with a maximum number of DL assignments in a DL association set, the number of HARQ-ACK bits that are reported for the given serving cell may be limited by the first parameter. This may be accomplished as described in connection with FIG. 8. Therefore, instead of reporting all subframes in the DL association set, the first parameter may limit the number of HARQ-ACK bits for a serving cell.

The UE PUCCH format 3 reporting module 130 may monitor the DL DAI filed in DCI in the PDCCH or enhanced physical downlink control channel (EPDCCH) to determine the ordering and multiplexing of the HARQ-ACK bits. If the received maximum DL DAI is less than the first parameter, the remaining bits may be set to DTX. This is different from traditional PUCCH format 3 procedures where the ACK/NACK bits of each cell are ordered based on the subframe indexes in the DL association set and the ACK/NACK of all subframes in a DL association set are reported even if they are not used.

The UE operations module 124 may provide information 148 to the one or more receivers 120. For example, the UE operations module 124 may inform the receiver(s) 120 when or when not to send PDSCH HARQ-ACK information based on the set of downlink subframe associations.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the transmission data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include one or more of an eNB first parameter module 194, an eNB PUCCH format 1b reporting module 196 and an eNB PUCCH format 3 reporting module 198.

The eNB first parameter module 194 may determine a first parameter that defines a maximum number of elements with downlink (DL) assignments for a subframe in the DL association set for a serving cell (e.g., M_{config}). Multiple serving cells may be configured for carrier aggregation.

In one configuration, the first parameter may be a fixed value. For example, the first parameter may be pre-defined as 4. In another configuration, the first parameter may be configured by higher layer signaling (e.g., RRC signaling) from the eNB 160. In other words, the eNB 160 may configure the UE 102 to limit the maximum number of elements with DL assignments for subframe n in the DL association set K by a higher layer signaling. In yet another configuration, the first parameter may be based on a DL-reference UL/DL configuration or the PCell UL/DL configuration.

In one configuration, the first parameter may be cell-specific. In another configuration, the first parameter may be UE-specific.

The eNB PUCCH format 1b reporting module 196 may configure the UE 102 with PUCCH format 1b with channel selection. In this case, the eNB PUCCH format 1b reporting module 196 may receive PDSCH HARQ-ACK information based on the first parameter using PUCCH format 1b with channel selection. If PUCCH format 1b with channel selection is configured, the eNB PUCCH format 1b reporting module 196 may assume that the first parameter is configured. The eNB PUCCH format 1b reporting module 196 may receive HARQ-ACK bits for a serving cell according to the first parameter. This may be accomplished as described in connection with FIG. 7.

If a DL association set has more than 4 subframes, and if 4 or less DL or special subframes are assigned to the UE 102, PUCCH format 1b with channel selection can be supported. Furthermore, the channel selection table for TDD CA in Release-10, 11, or 12 can be reused. In one configuration, the eNB 160 may configure the UE 102 with the first parameter for a FDD SCell to support PUCCH format 1b with channel selection.

The eNB PUCCH format 1b reporting module 196 may receive HARQ-ACK bits based on a DL DAI filed in downlink control information. The ordering and multiplexing of the HARQ-ACK bits may be based on a DL DAI filed in the downlink control information sent by the eNB 160. If the maximum DL DAI is less than the first parameter, the remaining HARQ-ACK bits may be set to discontinuous transmission (DTX).

The eNB PUCCH format 3 reporting module 198 may configure the UE 102 with PUCCH format 3. In this case, the eNB PUCCH format 3 reporting module 198 may receive PDSCH HARQ-ACK information based on the first parameter using PUCCH format 3. For a serving cell configured with a maximum number of DL assignments in a DL association set, the number of HARQ-ACK bits that are reported for the given serving cell may be limited by the first parameter. This may be accomplished as described in connection with FIG. 8. Therefore, instead of reporting all subframes in the DL association set, the first parameter may limit the number of HARQ-ACK bits for a serving cell.

The eNB PUCCH format 3 reporting module 198 may receive HARQ-ACK bits based on a DL DAI filed in downlink control information. The ordering and multiplexing of the HARQ-ACK bits may be based on a DL DAI filed in the downlink control information sent by the eNB 160. If the maximum DL DAI is less than the first parameter, the remaining HARQ-ACK bits may be set to discontinuous transmission (DTX).

The eNB operations module 182 may provide information 190 to the one or more receivers 178. For example, the eNB operations module 182 may inform the receiver(s) 178 when or when not to receive PDSCH HARQ-ACK information based on the set of downlink subframe associations.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode transmission data 105 and/or other information 101.

The encoder 109 may encode transmission data 105 and/or other information 101 provided by the eNB operations module 182. For example, encoding the transmission data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

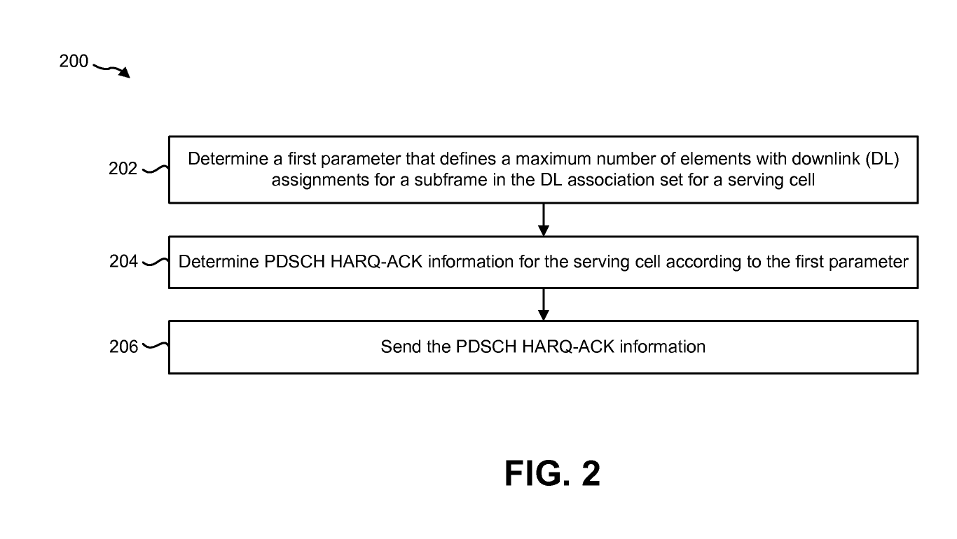

FIG. 2 is a flow diagram illustrating one implementation of a method 200 for performing carrier aggregation by a UE 102. The UE 102 may be located in a wireless communication network in which carrier aggregation may be performed with one or more FDD cells and one or more TDD cells. In one implementation, the wireless communication network may be an LTE network.

The UE 102 may communicate with an eNB 160 over a serving cell using either FDD or TDD duplexing. A serving cell may be a set of communication channels (e.g., downlink channel 119 and uplink channel 121). Multiple serving cells may be configured. During carrier aggregation (CA), more than one serving cell may be aggregated to the UE 102.

The UE 102 may determine 202 a first parameter that defines a maximum number of elements with DL assignments for a subframe in the DL association set for a serving cell. In carrier aggregation, the UE 102 may be configured with more than one serving cell. In some configurations, a serving cell may be a TDD cell with frame structure type 2 or a FDD cell with frame structure type 1. A UE 102 may be configured with serving cells with both frame structure type 1 and frame structure type 2. This may be referred to as TDD-FDD CA.

In one case, the PCell is a TDD cell and the SCell is a FDD cell with DL only. In this case, the SCell may be considered as having a frame structure type 2 with a new TDD UL/DL configuration 7, which only includes DL subframes. Therefore, in this case, TDD-FDD CA may also be considered as a type of TDD CA.

The CA may provide more potential DL and UL subframes for data transmission, which may increase the peak throughput of a UE 102. The DL and UL resources may be shared with other UEs 102 in the same serving cell. It is very rare and unlikely that a single UE 102 is assigned with all DL resources. Therefore, the eNB 160 may schedule the channel resources among different UEs 102.

For a TDD serving cell, a UE 102 may monitor all DL subframes in a DL association set to detect whether there is PDSCH assigned to the UE 102. The HARQ-ACK bits corresponding to a PDSCH transmission may be generated based on the DL association set according to Table (1) (from 3GPP TS 36.213, Table 10.1.3.1-1). Table (1) provides a downlink association set index K: {k₀, k₁, . . . k_{M-1}} for TDD for a subframe n in a UL/DL configuration.

TABLE (1)

| UL/DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

For a FDD serving cell in TDD-FDD CA, when the primary serving cell is a TDD serving cell, a UE 102 may monitor the PDCCH or an enhanced PDCCH (EPDCCH) in all DL subframes in a corresponding DL association set to detect whether there is a PDSCH assigned to the UE 102. It should be noted that a discontinuous reception (DRX) or a measurement gap can be controlled by higher layers to disable monitoring PDCCH/EPDCCH subframes.

In the second TDD-FDD CA option discussed above, a DL-reference UL/DL configuration may be configured on a FDD serving cell by higher layer radio resource control (RRC) signaling. In this second option, the TDD CA methods can be reused, and the DL association set for the FDD cell may be based on Table (1) above.

In the first option for TDD-FDD CA discussed above, a DL association set may be defined for a FDD cell based on a TDD reference UL/DL configuration. In this first option, the DL association set for a FDD cell may be determined based on a TDD PCell UL/DL configuration or the DL-reference UL/DL configuration of the TDD PCell. Table (2) below shows an example of the DL association set of a FDD cell in TDD-FDD CA. Table (2) provides the DL association set index K: {k₀, k₁, . . . k_{M-1}} of a FDD cell based on a TDD reference UL/DL configuration.

TABLE (2)

| Reference | | | | | | | | | | |
|---|---|---|---|---|---|---|---|---|---|---|
| UL/DL | Subframe n | | | | | | | | | |
| Configuration | 0 | 1 | 2 | 3 | 4 | 5 | 6 | 7 | 8 | 9 |
| 0 | — | — | 6, 5 | 5, 4 | 4 | — | — | 6, 5 | 5, 4 | 4 |
| 1 | — | — | 7, 6, 5 | 5, 4 | — | — | — | 7, 6, 5 | 5, 4 | — |
| 2 | — | — | 8, 7, 6, 5, 4 | — | — | — | — | 8, 7, 6, | — | — |
| | | | | | | | | 5, 4 | | |
| 3 | — | — | 11, 10, 9, 8, 7, 6 | 6, 5 | 5, 4 | — | — | — | — | — |
| 4 | — | — | 12, 11, 10, 9, 8, 7 | 7, 6, 5, 4 | — | — | — | — | — | — |
| 5 | — | — | 13, 12, 11, 10, | — | — | — | — | — | — | — |
| | | | 9, 8, 7, 6, 5, 4 | | | | | | | |
| 6 | — | — | 8, 7 | 7, 6 | 6, 5 | — | — | 7 | 7, 6, 5 | — |

For HARQ-ACK on a PUSCH that is adjusted based on a detected PDCCH/EPDCCH with DCI format 0/4 intended for the UE 102, a UL downlink assignment index (DAI) V_{DAI}^{UL} or W_{DAI}^{UL} in DCI format 0/4 may be used to adjust the HARQ-ACK payload of a serving cell. V_{DAI}^{UL} may be used for a UE 102 configured with a single TDD serving cell, and W_{DAI}^{UL} may be used for a UE 102 that is configured with more than one serving cell.

The UL DAI values may be used to determine the total number of subframes with PDSCH transmissions and with PDCCH/EPDCCH indicating downlink SPS release to the corresponding UE 102 within all the subframe(s) n−k, where kεK of the DL association set of the given uplink subframe. Furthermore, each PDSCH transmission to the UE 102 in serving cell c may be ordered with a DL DAI V_{DAI,c}^{DL}. The DL DAI may count the number of PDSCHs up to the given PDSCH transmission. For example, a DL DAI may be 1, 2, 3 in subframe x, y, z in the set K. In this case, the UL DAI is 3, which may be indicated in the UL grant (normally from the last DL subframe in the set K).

In one configuration, V_{DAI,c}^{DL} is the value of the DAI in PDCCH/EPDCCH with one of the DCI formats 1, 1A, 1B, 1D, 2, 2A, 2B, 2C or 2D (e.g., 1/1A/1B/1D/2/2A/2B/2C/2D) detected by the UE 102 according to Table (5) below in subframe n−kₘ in serving cell c. In this configuration, kₘ is the smallest value in the DL association set K, where K is the DL association set for the FDD cell, such that the UE 102 detects a DCI format 1/1A/1B/1D/2/2A/2B/2C/2D. However, for HARQ-ACK reporting on PUCCH, the HARQ-ACK bits for all subframes in a DL association may be reported if there is a PDSCH transmission on an SCell, even if there is no PDSCH allocated for the UE 102 in most of the DL subframes in a DL association set.

In TDD CA, M_{c} of a serving cell c denotes the number of elements for subframe n in the DL association set K_{c} for the serving cell. Set K_{c} may contain values of kεK such that subframe n−k corresponds to a DL subframe or a special subframe for serving cell c. K may be defined in Table (1) above (where “UL/DL configuration” in Table (1) refers to the “DL-reference UL/DL configuration”) and may be associated with subframe n.

A UE 102 is unlikely to be assigned with all DL subframes. Therefore, a UE 102 may be configured with a maximum number of elements with DL assignments for subframe n in the DL association set K of a serving cell to a UE 102. A first parameter may define the maximum number of elements with DL assignments for a subframe in the downlink association set for a serving cell. The first parameter may be referred to as M_{config}. The first parameter (e.g., M_{config}) of a serving cell should be less than the maximum M_{c} of all subframes of the given serving cell. The UE 102 should expect that no more than M_{config} subframes will be used for PDSCH allocation for the given UE 102. Thus, the existing format 1b with channel selection tables for TDD CA can be reused if M_{config} is less than or equal to 4.

The UE 102 can be configured with the first parameter. In other words, the UE 102 may be configured with M_{config} that defines a maximum number of elements with DL assignments for subframe n in the DL association set K for each serving cell. In a first configuration, M_{config} may be a fixed number. For example, M_{config} may be predefined as 4. The UE 102 may be configured to limit a maximum number of elements with DL assignments for subframe n in the DL association set K by a higher layer (e.g., RRC) signaling.

In a second configuration, M_{config} may be configured by a higher layer (e.g., RRC) signaling. For example, the UE 102 may receive M_{config} via higher layer signaling from the eNB 160. The higher layer signaling may be dedicated signaling or broadcasting signaling.

In a third configuration, M_{config} may be pre-defined. In this configuration, M_{config} may be based on a DL-reference UL/DL configuration or the PCell UL/DL configuration.

M_{config} may be UE-specific and applied on all configured serving cells of a UE 102. In this configuration, the M_{config} may be applied to all serving cells. In another implementation, the M_{config} may be applied to all SCells.

M_{config} may be cell-specific for a serving cell. In this configuration, a M_{config} corresponding to a specific cell c may be referred to as M_{config}_{_{—}}_{c}. The same or different M_{config}_{_{—}}_{c} may be configured for different serving cells.

The UE 102 may determine 204 PDSCH HARQ-ACK information for the serving cell according to the first parameter. The UE 102 may determine a number of HARQ-ACK bits for the serving cell according to the first parameter. For a PUCCH report in subframe n, when M_{c} of the cell is less than M_{config}, the UE 102 may generate M_{c} HARQ-ACK bits based on the subframe ordering in the DL association set. However, when M_{c} of the cell is greater than M_{config}, the UE 102 may generate M_{config} bits of HARQ-ACK bits based on the DL DAI ordering for the subframes in the DL association set.

If the serving cell is a secondary cell, for 0≦j≦M_{config}−1, if a PDSCH transmission with a corresponding PDCCH/EPDCCH and a DAI value in the PDCCH/EPDCCH equal to j+1 is received, HARQ-ACK(j) is the corresponding ACK/NACK/DTX response; otherwise HARQ-ACK(j) may be set to DTX. If the serving cell is a primary cell, and there is a PDSCH transmission on the primary cell without a corresponding PDCCH/EPDCCH detected within the subframe(s) n−k, where kεK of the primary cell, HARQ-ACK(0) may be the ACK/NACK/DTX response for the PDSCH transmission without a corresponding PDCCH/EPDCCH.

For 1≦j≦M_{config}−1, if a PDSCH transmission with a corresponding PDCCH/EPDCCH and a DAI value in the PDCCH/EPDCCH equal to j or a PDCCH/EPDCCH indicating downlink SPS release and with a DAI value in the PDCCH/EPDCCH equal to j is received, HARQ-ACK(j) may be the corresponding ACK/NACK/DTX response; otherwise HARQ-ACK(j) may be set to DTX.

If the serving cell is a primary cell, and there is no PDSCH transmission on the primary cell without a corresponding PDCCH/EPDCCH detected within the subframe(s) n−k, where kεK of the primary cell, for 0≦j≦M_{config}−1 and the TDD UL/DL configuration of the primary cell belonging to {1,2,3,4,6}, if a PDSCH transmission with a corresponding PDCCH/EPDCCH and DAI value in the PDCCH/EPDCCH equal to j+1 or a PDCCH/EPDCCH indicating downlink SPS release and with DAI value in the PDCCH/EPDCCH equal to j+1 is received, HARQ-ACK(j) may be the corresponding ACK/NACK/DTX response; otherwise HARQ-ACK(j) may be set to DTX.

For 0≦j≦M_{config}−1 and the primary cell with TDD UL/DL configuration 0, if a PDSCH transmission with a corresponding PDCCH/EPDCCH or a PDCCH/EPDCCH indicating downlink SPS release is received, HARQ-ACK(0) may be the corresponding ACK/NACK/DTX response; otherwise HARQ-ACK(j) may be set to DTX.

The UE may send 206 the PDSCH HARQ-ACK information. The UE 102 may send 206 the PDSCH HARQ-ACK information to the eNB 160. The PDSCH HARQ-ACK information may be sent in a PUCCH report in subframe n. In one configuration, the UE 102 may send 206 the PDSCH HARQ-ACK information using PUCCH format 1b with channel selection, as described below in connection with FIG. 7. In another configuration, the UE 102 may send 206 the PDSCH HARQ-ACK information using PUCCH format 3, as described below in connection with FIG. 8.

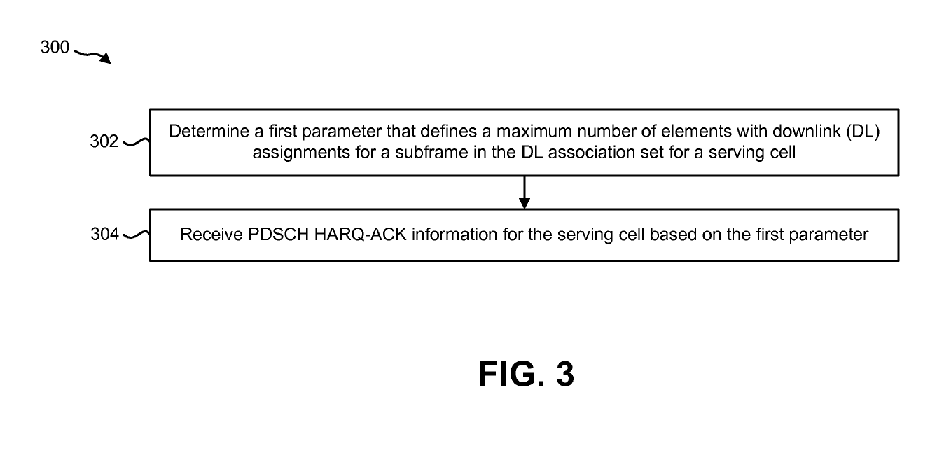

FIG. 3 is a flow diagram illustrating one implementation of a method 300 for performing carrier aggregation by an eNB 160. The eNB 160 may be located in a wireless communication network in which carrier aggregation may be performed with one or more FDD cells and one or more TDD cells. In one implementation, the wireless communication network may be an LTE network.

The eNB 160 may communicate with a UE 102 over a serving cell using either FDD or TDD duplexing. A serving cell may be a set of communication channels 119, 121. Multiple serving cells may be configured. During carrier aggregation (CA), more than one serving cell may be aggregated to the UE 102.

The eNB 160 may determine 302 a first parameter that defines a maximum number of elements with DL assignments for a subframe in the DL association set for a serving cell. The first parameter may be referred to as M_{config}. The first parameter (e.g., M_{config}) of a serving cell should be less than the maximum M_{c} of all subframes of the given serving cell. The UE 102 should expect that no more than M_{config} subframes will be used for PDSCH allocation for the given UE 102.

In one configuration, the eNB 160 may send the first parameter via higher layer signaling to the UE 102. In another configuration, the first parameter may be a fixed value (e.g., 4). The higher layer signaling may be dedicated signaling or broadcasting signaling. In yet another configuration, the first parameter may be pre-defined. In this configuration, the first parameter may be based on a DL-reference UL/DL configuration or the PCell UL/DL configuration.

The first parameter may be UE-specific and applied on all configured serving cells of a UE 102. In this configuration, the first parameter may be applied to all serving cells. In another implementation, the first parameter may be applied to all SCells.

In another configuration, the first parameter may be cell-specific for a serving cell. In this configuration, the first parameter corresponding to a specific cell c may be referred to as M_{config,c}. The same or different M_{config,c} may be configured for different serving cells.

The eNB 160 may receive 304 PDSCH HARQ-ACK information for the serving cell based on the first parameter. The eNB 160 may receive 304 the PDSCH HARQ-ACK information from the UE 102. The UE 102 may determine a number of HARQ-ACK bits for the serving cell according to the first parameter. The PDSCH HARQ-ACK information may be received 304 in a PUCCH report in subframe n.

In one case, the eNB 160 may configure the UE 102 with PUCCH format 1b with channel selection. In this case, the eNB 160 may receive 304 the PDSCH HARQ-ACK information from the UE 102 using PUCCH format 1b with channel selection, as described below in connection with FIG. 7. If the UE 102 is configured with PUCCH format 1b with channel selection, the first parameter is assumed to be set.

In this case, the number of elements for the subframe of the DL association set in the serving cell may be determined according to max(M_{primary}, min(M_{secondary},M_{config})). M_{primary} is the number of elements for the subframe of the DL association set in a primary cell. M_{secondary} is the number of elements for the subframe of the DL association set in a secondary cell. M_{config} is the first parameter.

In one configuration, the PCell may be a TDD cell with a DL-reference UL/DL configuration 0, 1, 2, 3, 4 or 6. In other words, the DL-reference UL/DL configuration of the PCell may belong to a TDD UL/DL configuration in the set of {0,1,2,3,4,6}. In this configuration, the SCell may be a FDD cell.

In another configuration, every serving cell is a TDD cell. The DL-reference UL/DL configuration of the PCell may belong to a TDD UL/DL configuration in the set of { 0,1,2,3,4,6}. A DL-reference UL/DL configuration of the SCell may belong to TDD UL/DL configuration 5.

In another case, the eNB 160 may configure the UE 102 with PUCCH format 3. The eNB 160 may receive 304 the PDSCH HARQ-ACK information from the UE 102 using PUCCH format 3, as described below in connection with FIG. 8. In this case, the PDSCH HARQ-ACK information may be generated based on the minimum number between the number of elements with DL assignments for the subframe in the DL association set for the serving cell and the first parameter. In other words, the PDSCH HARQ-ACK information may include M=min(M_{c},M_{config,c}) HARQ-ACK bits for a given serving cell c, where M_{c} is the number of elements in the DL association set K_{c}. In one configuration, the PCell is a TDD cell and the SCell is a FDD cell. In another configuration, every serving cell is a TDD cell and the DL-reference UL/DL configuration of the PCell may belong to a TDD UL/DL configuration in the set of {0,1,2,3,4,6}.

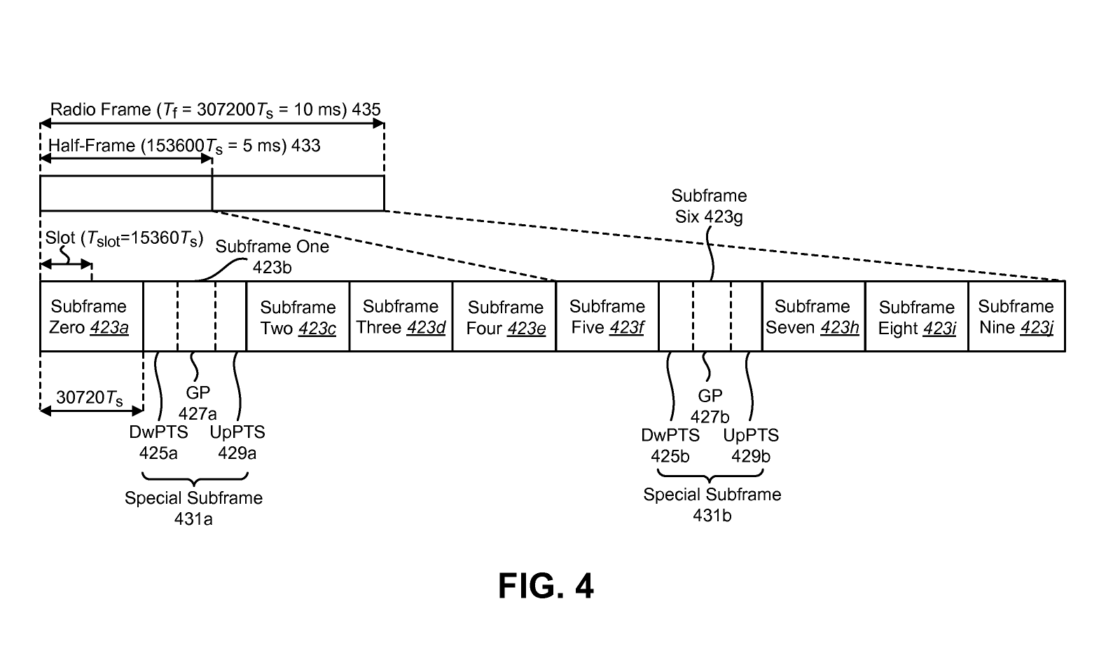

FIG. 4 is a diagram illustrating one example of a radio frame 435 that may be used in accordance with the systems and methods disclosed herein. This radio frame 435 structure illustrates a TDD structure. Each radio frame 435 may have a length of T_{f}=307200·Tₛ=10 ms, where T_{f} is a radio frame 435 duration and Tₛ is a time unit equal to

$$\frac{1}{( 15000 \times 2048 )}$$

seconds. The radio frame 435 may include two half-frames 433, each having a length of 153600·Tₛ=5 ms. Each half-frame 433 may include five subframes 423a-e, 423f-j each having a length of 30720·Tₛ=1 ms.

TDD UL/DL configurations 0-6 are given below in Table (3) (from Table 4.2-2 in 3GPP TS 36.211). UL/DL configurations with both 5 millisecond (ms) and 10 ms downlink-to-uplink switch-point periodicity may be supported. In particular, seven UL/DL configurations are specified in 3GPP specifications, as shown in Table (3) below. In Table (3), “D” denotes a downlink subframe, “S” denotes a special subframe and “U” denotes a UL subframe.

TABLE (3)

| | Downlink- | | | | | | | | | | |
|---|---|---|---|---|---|---|---|---|---|---|---|
| TDD UL/DL | to-Uplink | | | | | | | | | | |
| Con- | Switch- | | | | | | | | | | |
| figuration | Point | Subframe Number | | | | | | | | | |
| Number | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table (3) above, for each subframe in a radio frame, “D” indicates that the subframe is reserved for downlink transmissions, “U” indicates that the subframe is reserved for uplink transmissions and “S” indicates a special subframe with three fields: a downlink pilot time slot (DwPTS), a guard period (GP) and an uplink pilot time slot (UpPTS). The length of DwPTS and UpPTS is given in Table (4) (from Table 4.2-1 of 3GPP TS 36.211) subject to the total length of DwPTS, GP and UpPTS being equal to 30720·Tₛ=1 ms. In Table (4), “cyclic prefix” is abbreviated as “CP” and “configuration” is abbreviated as “Config” for convenience.

TABLE (4)

| | Normal CP in downlink | | | Extended CP in downlink | | |
|---|---|---|---|---|---|---|
| | | UpPTS | | | UpPTS | |
| Special | | | Extended | | | Extended |
| Subframe | | Normal | CP in | | Normal | CP in |
| Config | DwPTS | CP in uplink | uplink | DwPTS | CP in uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

UL/DL configurations with both 5 ms and 10 ms downlink-to-uplink switch-point periodicity are supported. In the case of 5 ms downlink-to-uplink switch-point periodicity, the special subframe exists in both half-frames. In the case of 10 ms downlink-to-uplink switch-point periodicity, the special subframe exists in the first half-frame only. Subframes 0 and 5 and DwPTS may be reserved for downlink transmission. UpPTS and the subframe immediately following the special subframe may be reserved for uplink transmission.

In accordance with the systems and methods disclosed herein, some types of subframes 423 that may be used include a downlink subframe, an uplink subframe and a special subframe 431. In the example illustrated in FIG. 4, which has a 5 ms periodicity, two standard special subframes 431a-b are included in the radio frame 435.

The first special subframe 431a includes a downlink pilot time slot (DwPTS) 425a, a guard period (GP) 427a and an uplink pilot time slot (UpPTS) 429a. In this example, the first standard special subframe 431a is included in subframe one 423b. The second standard special subframe 431b includes a downlink pilot time slot (DwPTS) 425b, a guard period (GP) 427b and an uplink pilot time slot (UpPTS) 429b. In this example, the second standard special subframe 431b is included in subframe six 423g. The length of the DwPTS 425a-b and UpPTS 429a-b may be given by Table 4.2-1 of 3GPP TS 36.211 (illustrated in Table (4) above) subject to the total length of each set of DwPTS 425, GP 427 and UpPTS 429 being equal to 30720·Tₛ=1 ms.

Each subframe i 423a-j (where i denotes a subframe ranging from subframe zero 423a (e.g., 0) to subframe nine 423j (e.g., 9) in this example) is defined as two slots, 2i and 2i+1 of length Tₛₗₒₜ=15360·Tₛ=0.5 ms in each subframe 423. For example, subframe zero (e.g., 0) 423a may include two slots, including a first slot.

UL/DL configurations with both 5 ms and 10 ms downlink-to-uplink switch-point periodicity may be used in accordance with the systems and methods disclosed herein. FIG. 4 illustrates one example of a radio frame 435 with 5 ms switch-point periodicity. In the case of 5 ms downlink-to-uplink switch-point periodicity, each half-frame 433 includes a standard special subframe 431a-b. In the case of 10 ms downlink-to-uplink switch-point periodicity, a special subframe 431 may exist in the first half-frame 433 only.

Subframe zero (e.g., 0) 423a and subframe five (e.g., 5) 423f and DwPTS 425a-b may be reserved for downlink transmission. The UpPTS 429a-b and the subframe(s) immediately following the special subframe(s) 431a-b (e.g., subframe two 423c and subframe seven 423h) may be reserved for uplink transmission. It should be noted that, in some implementations, special subframes 431 may be considered DL subframes in order to determine a set of DL subframe associations that indicate UCI transmission uplink subframes of a UCI transmission cell.

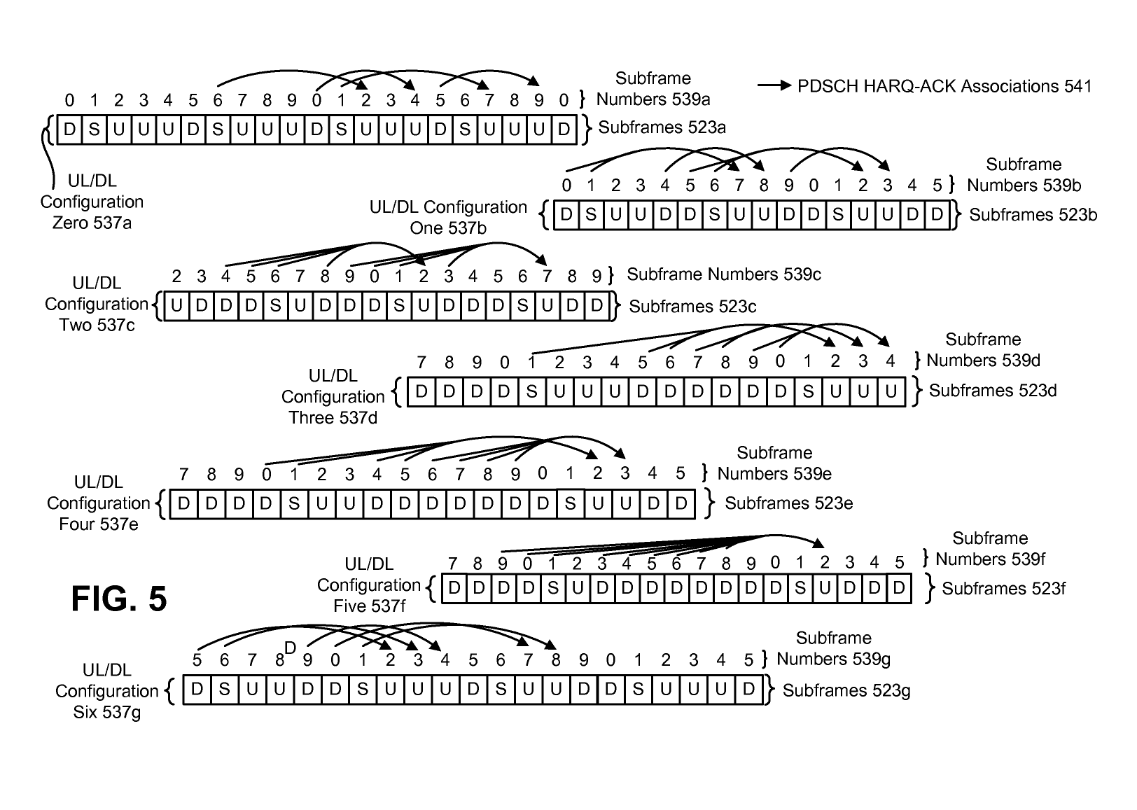

FIG. 5 is a diagram illustrating some TDD UL/DL configurations 537a-g in accordance with the systems and methods described herein. There are seven different TDD UL/DL configurations, all with different association timings. In particular, FIG. 5 illustrates UL/DL configuration zero 537a (e.g., “UL/DL configuration 0”) with subframes 523a and subframe numbers 539a, UL/DL configuration one 537b (e.g., “UL/DL configuration 1”) with subframes 523b and subframe numbers 539b, UL/DL configuration two 537c (e.g., “UL/DL configuration 2”) with subframes 523c and subframe numbers 539c and UL/DL configuration three 537d (e.g., “UL/DL configuration 3”) with subframes 523d and subframe numbers 539d. FIG. 5 also illustrates UL/DL configuration four 537e (e.g., “UL/DL configuration 4”) with subframes 523e and subframe numbers 539e, UL/DL configuration five 537f (e.g., “UL/DL configuration 5”) with subframes 523f and subframe numbers 539f and UL/DL configuration six 537g (e.g., “UL/DL configuration 6”) with subframes 523g and subframe numbers 539g.

FIG. 5 further illustrates PDSCH HARQ-ACK associations 541 (e.g., PDSCH HARQ-ACK feedback on PUCCH or PUSCH associations). The PDSCH HARQ-ACK associations 541 may indicate HARQ-ACK reporting subframes corresponding to subframes for PDSCH transmissions (e.g., subframes in which PDSCH transmissions may be sent and/or received). It should be noted that some of the radio frames 435 illustrated in FIG. 5 have been truncated for convenience.

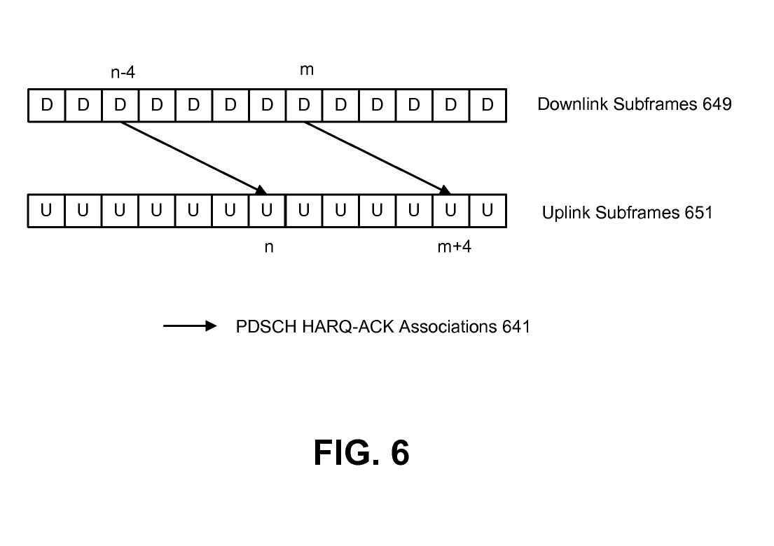

FIG. 6 illustrates the association timings of a FDD cell. The FDD cell may include paired downlink subframes 649 and uplink subframes 651. The PDSCH HARQ-ACK associations 641 for an FDD cell are illustrated. The PDSCH HARQ-ACK associations 641 may indicate HARQ-ACK reporting subframes corresponding to subframes for PDSCH transmissions (e.g., subframes in which PDSCH transmissions may be sent and/or received). In some implementations, the PDSCH HARQ-ACK reporting may occur on a PUCCH or a PUSCH.

A fixed 4 ms interval may be applied to the PDSCH HARQ-ACK associations 641. In one implementation, each of the downlink subframes 649 and uplink subframes 651 may be 1 ms. Therefore, the PDSCH HARQ-ACK transmission in subframe m+4 may be associated with a PDSCH transmission in subframe m. Similarly, a PDSCH transmission in subframe n−4 may be associated with the PDSCH HARQ-ACK transmission in subframe n.

FIG. 7 is a flow diagram illustrating a detailed configuration of a method 700 for performing carrier aggregation by a UE 102. The UE 102 may be located in a wireless communication network in which carrier aggregation may be performed with one or more FDD cells and one or more TDD cells. In one implementation, the wireless communication network may be an LTE network.

The UE 102 may communicate with an eNB 160 over a serving cell using either FDD or TDD duplexing. A serving cell may be a set of communication channels 119, 121. Multiple serving cells may be configured. During carrier aggregation (CA), more than one serving cell may be aggregated to a UE 102.

The UE 102 may be configured 702 with PUCCH format 1b with channel selection. The UE 102 may receive signaling from the eNB 160 instructing the UE 102 to report PDSCH HARQ-ACK information using PUCCH format 1b with channel selection. For HARQ-ACK multiplexing, a UE 102 may be configured with PUCCH format 1b or PUCCH format 3 by higher layer RRC signaling. PUCCH format 1b with channel selection may be supported for two serving cells only.

The UE 102 may determine 704 a first parameter that defines a maximum number of elements with DL assignments for a subframe in the DL association set for a serving cell. In one configuration, the first parameter may be M_{config}. The UE 102 may determine 704 the first parameter as described above in connection with FIG. 2. If PUCCH format 1b with channel selection is configured, the UE 102 may assume that the first parameter is set.

The UE 102 may determine 706 PDSCH HARQ-ACK information for the serving cell. One potential issue of more than 4 subframes in a FDD DL association set is the support of PUCCH format 1b with channel selection. In Release-10 and 11, format 1b with channel selection is supported for 2 cells. In TDD CA, format 1b with channel selection is supported for a maximum of 4 subframes in a DL association set. Therefore, the systems and methods described herein provide support for more than 4 subframes in a DL association set.

In a first approach, a new channel selection table considering 5 possible subframes may be defined. This will introduce bundling of some subframes. There are a total of 32 possible ACK/NACK situations in 5 subframes of an SCell, but a channel selection table has only limited entries to report HARQ-ACK feedback of both the PCell and the SCell.

In a second approach, the first parameter of a serving cell may be configured to a UE 102. For example, M_{config} may be less than or equal to 4. The UE 102 should expect that no more than a M_{config} number of subframes are used for PDSCH allocation for the given UE 102. Thus, the existing format 1b with channel selection tables for TDD CA can be reused.

If the number of DL subframes in a DL association set is greater than 4 in a cell, a UE 102 can be configured with M_{config}, which defines a maximum number of elements with DL assignments for subframe n in the DL association set K for the secondary cell. In one case, M_{config} may be a fixed number (e.g. 4). The UE 102 may be configured to limit a maximum number of elements with DL assignments for subframe n in the DL association set K by a higher layer (e.g., RRC) signaling. In another case, M_{config} may be configured by a higher layer (e.g., RRC) signaling, where M_{config} is less than or equal to 4. It should be noted that for PUCCH format 1b with channel selection, M_{config} may only correspond to the secondary cell.

In existing PUCCH HARQ-ACK reports for a single TDD serving cell, the ACK/NACK bit of all subframes in a DL association set is reported and multiplexed based on the ordering of the indexes in the DL association set of Table (1) above. For TDD HARQ-ACK multiplexing and sub-frame n with M>1 and one configured serving cell, where M is the number of elements in the DL association set K defined in Table (1) above, n_{PUCCH,i}⁽¹⁾ may be denoted as the PUCCH resource derived from sub-frame n−kᵢ and HARQ-ACK(i) as the ACK/NACK/DTX response from sub-frame n−kᵢ, where kᵢεK.

For TDD HARQ-ACK multiplexing with PUCCH format 1b with channel selection and sub-frame n with M>2 and two configured serving cells, the HARQ-ACK bits may be generated based on the DL DAI V_{DAI}^{UL} values of each PDSCH transmission. For the primary cell, if there is a PDSCH transmission on the primary cell without a corresponding PDCCH/EPDCCH detected within the subframe(s) n−k, where kεK, HARQ-ACK(0) may be the ACK/NACK/DTX response for the PDSCH transmission without a corresponding PDCCH/EPDCCH.

For 1≦j≦M−1, if a PDSCH transmission with a corresponding PDCCH/EPDCCH and DAI value in the PDCCH/EPDCCH equal to j or a PDCCH/EPDCCH indicating downlink SPS release and with DAI value in the PDCCH/EPDCCH equal to j is received, HARQ-ACK(j) may be the corresponding ACK/NACK/DTX response; otherwise HARQ-ACK(j) may be set to DTX.

For a primary cell, if there is not a PDSCH transmission on the primary cell without a corresponding PDCCH/EPDCCH detected within the subframe(s) n−k, where kεK, for 0≦j≦M−1 and TDD UL/DL configuration of the primary cell belonging to {1,2,3,4,6}, if a PDSCH transmission with a corresponding PDCCH/EPDCCH and DAI value in the PDCCH/EPDCCH equal to j+1 or a PDCCH/EPDCCH indicating downlink SPS release and with DAI value in the PDCCH/EPDCCH equal to j+1 is received, HARQ-ACK(j) may be the corresponding ACK/NACK/DTX response; otherwise HARQ-ACK(j) may be set to DTX.

For 0≦j≦M−1 and the primary cell with TDD UL/DL configuration 0, if a PDSCH transmission with a corresponding PDCCH/EPDCCH or a PDCCH/EPDCCH indicating downlink SPS release is received, HARQ-ACK(0) may be the corresponding ACK/NACK/DTX response; otherwise HARQ-ACK(j) may be set to DTX.

For a secondary cell, for 0≦j≦M−1, if a PDSCH transmission with a corresponding PDCCH/EPDCCH and DAI value in the PDCCH/EPDCCH equal to j+1 is received, HARQ-ACK(j) may be the corresponding ACK/NACK/DTX response; otherwise HARQ-ACK(j) may be set to DTX.

With the use of M_{config}, the UE 102 should monitor the DL DAI field V_{DAI}^{DL} in DCI format 1/1A/1B/1D/2/2A/2B/2C/2D, to determine the ordering and multiplexing of the HARQ-ACK bits. If the received maximum DL DAI is less than the maximum number of DL assignments in a DL association set (e.g., M_{config}), the remaining bits may be padded with discontinuous transmission (DTX) bits. The ACK/NACK generation and multiplexing may be similar to the HARQ-ACK reporting on PUSCH in Release-10 or 11. For a secondary cell with more than 4 subframes in the DL association set and M_{config}, for 0≦j≦M_{config}−1, if a PDSCH transmission with a corresponding PDCCH/EPDCCH and DAI value in the PDCCH/EPDCCH equal to j+1 is received, HARQ-ACK(j) may be the corresponding ACK/NACK/DTX response; otherwise HARQ-ACK(j) may be set to DTX.

In TDD-FDD CA, for a FDD cell with the number of subframes in a DL association set greater than 4, the value of the DAI in DCI format 1/1A/1B/1D/2/2A/2B/2C/2D denotes the accumulative number of PDCCH/EPDCCH(s) with assigned PDSCH transmission(s) up to the present subframe within subframe(s) n−k of each configured serving cell. In this configuration, kεK and K is the DL association set for the FDD cell. Furthermore, K may be updated from subframe to subframe.

In one configuration, V_{DAI,c}^{DL} may denote the value of the DAI in PDCCH/EPDCCH with DCI format 1/1A/1B/1D/2/2A/2B/2C/2D detected by the UE 102 according to Table (5) (from 3GPP TS 36.213 v11.4.0, Table 7.3-X) in subframe n−kₘ in serving cell c. kₘ is the smallest value in the DL association set K, and K is the DL association set for the FDD cell, such that the UE 102 detects a DCI format 1/1A/1B/1D/2/2A/2B/2C/2D. The UE 102 should not expect to receive a DL DAI value that is greater than M_{config}.

TABLE (5)

| | | Number of subframes with |
|---|---|---|
| | | PDSCH transmission |
| DAI | | and with PDCCH/EPDCCH |
| MSB, LSB | V_{DAI}^{UL} or V_{DAI}^{DL} | indicating DL SPS release |
| 0, 0 | 1 | 1 or 5 or 9 |
| 0, 1 | 2 | 2 or 6 |
| 1, 0 | 3 | 3 or 7 |
| 1, 1 | 4 | 0 or 4 or 8 |

As described above, the UE 102 may be configured with two serving cells in TDD-FDD CA where the PCell is a TDD cell and the SCell is FDD cell. For the PCell, the UE 102 may, upon detection of a PDSCH transmission within subframe(s) n−k for serving cell c, where kεK_{c} intended for the UE 102 and for which a HARQ-ACK response may be provided, transmit the HARQ-ACK response in UL subframe n. Set K_{c} may contain values of kεK such that subframe n−k corresponds to a DL subframe or a special subframe for serving cell c. Set K is defined in Table (1) above (where “UL/DL configuration” in Table (1) refers to the “DL-reference UL/DL configuration”) and is associated with subframe n. For the PCell, the DL-reference UL/DL configuration is the same of the PCell UL/DL configuration, and M_{primary} is the number of elements for subframe n in the DL association set K_{c}.

For the SCell, the UE 102 may, upon detection of a PDSCH transmission within subframe(s) n−k for serving cell c, where kεK_{c} intended for the UE 102 and for which HARQ-ACK response should be provided, transmit the HARQ-ACK response in UL subframe n. DL association set K_{c} may contain values of kεK such that subframe n−k corresponds to a DL subframe or a special subframe for serving cell c. DL association set K is associated with subframe n. For the first option for TDD-FDD CA discussed above, DL association set K is defined in the DL subframe set for the FDD cell. For the second option for TDD-FDD CA discussed above, DL association set K is defined in the DL subframe set of a DL-reference UL/DL configuration. M_{secondary} is the number of elements for subframe n in the DL association set K_{c}.

The PCell may be a TDD cell with a DL-reference UL/DL configuration belonging to one of a TDD UL/DL configuration 1, 2, 3, 4 or 6. In other words, the DL-reference UL/DL configuration of the PCell may belong to a TDD UL/DL configuration in set {0, 1, 2, 3, 4, 6}. Furthermore, the secondary cell may be a FDD cell. M_{secondary} may be more than 4 at least in one subframe. For example, the FDD SCell may have a DL association set with more than 4 DL subframes when the reference configuration of the FDD SCell is UL/DL configuration 2, 3, 4 or 5, as shown in Table (2) above. If the DL-reference UL/DL configuration of the PCell belongs to a TDD UL/DL configuration in set {0, 1, 2, 3, 4, 6}, and M_{secondary} is more than 4 at least in one subframe, PUCCH format 1b with channel selection can be supported if a maximum number of assigned subframes M_{config} is configured for a serving cell. In this case, M_{config} is less than or equal to 4.

Apart from TDD CA, if a UE 102 is configured with two serving cells, if the PCell is TDD and the SCell is FDD and if the DL-reference UL/DL configuration of PCell is TDD UL/DL configuration 5, PUCCH format 1b with channel selection may not be supported.

In TDD-FDD CA, if the DL-reference UL/DL configuration of PCell belongs to a TDD UL/DL configuration in the set of { 0,1,2,3,4,6}, and the DL-reference UL/DL configuration of SCell is more than 4 at least in one subframe, the UE 102 may be configured with M_{config} on the FDD secondary cell to support PUCCH format 1b with channel selection. The M_{config} may be a fixed value (e.g. 4) or configured by higher layer signaling. In another configuration, M_{config} may be pre-defined. In this configuration, M_{config} may be based on a DL-reference UL/DL configuration or the PCell UL/DL configuration. If PUCCH format 1b with channel selection is configured, the UE 102 should assume that M_{config} is configured.

In TDD CA, every serving cell is a TDD cell. If the DL-reference UL/DL configuration of the PCell belongs to a TDD UL/DL configuration in set {0, 1, 2, 3, 4, 6}, and the SCell belongs to DL-reference UL/DL configuration 5, PUCCH format 1b with channel selection can be supported if M_{config} is configured for the SCell. In this case, M_{config} is less than or equal to 4. The UE 102 may detect the value of the DAI in DCI format 1/1A/1B/1D/2/2A/2B/2C/2D. This value denotes the accumulative number of PDCCH/EPDCCH(s) with assigned PDSCH transmission(s) up to the present subframe within subframe(s) n−k of each configured serving cell, where kεK. K is the DL association set for the PCell, and may be updated from subframe to subframe.

As described above, V_{DAI,c}^{DL} is the value of the DAI in PDCCH/EPDCCH with DCI format 1/1A/1B/1D/2/2A/2B/2C/2D detected by the UE 102 according to Table (5) in subframe n−kₘ in serving cell c. In this case, kₘ is the smallest value in the DL association set K, where K is the DL association set for the TDD serving cell, such that the UE 102 detects a DCI format 1/1A/1B/1D/2/2A/2B/2C/2D. The UE 102 should not expect to receive a DL DAI value that is greater than M_{config}. If the serving cell is a secondary cell, for 0≦j≦M_{config}−1, if a PDSCH transmission with a corresponding PDCCH/EPDCCH and DAI value in the PDCCH/EPDCCH equal to j+1 is received, HARQ-ACK(j) is the corresponding ACK/NACK/DTX response; otherwise HARQ-ACK(j) may be set to DTX.

In one TDD CA case, the DL-reference UL/DL configuration of PCell may belong to a TDD UL/DL configuration in the set of {0,1,2,3,4,6}, and the DL-reference UL/DL configuration of SCell may belong to a TDD UL/DL configuration 5. In this case, the UE 102 may be configured with M_{config} on the TDD secondary cell to support PUCCH format 1b with channel selection. The M_{config} may be a fixed value (e.g. 4), pre-defined or configured by higher layer signaling. If PUCCH format 1b and channel selection is configured, the UE 102 should assume that M_{config} is configured.

If M_{config} is greater than M_{secondary} in a given UL subframe n, the M_{secondary} should be used instead of M_{config}, and the HARQ-ACK bits may be generated as provided in Release-10, 11 and 12 PUCCH reports. For example, in Table (2), DL-reference UL/DL configuration 3 and UL subframe 2 has a subframe set with six subframes, and UL subframes 3 and 4 have only two subframes in the corresponding subframe set. Therefore, if a M_{config}=4 is configured, for PUCCH format 1b with channel selection, M_{config} and HARQ-ACK bits based on DL DAI should be used in subframe 2, and normal M_{secondary}=2 and HARQ-ACK bits are generated for PUCCH reporting in subframes 3 and 4.

If M_{config} is less than M_{secondary} in a given UL subframe n, the HARQ-ACK bits of the FDD serving cell may be generated based on the order of the DL DAI V_{DAI,c}^{DL} instead of the order in the DL association set. And M_{config} bits of HARQ-ACK are generated for the FDD serving cell. If the serving cell is a secondary cell, for 0≦j≦M_{config}−1, if a PDSCH transmission with a corresponding PDCCH/EPDCCH and DAI value in the PDCCH/EPDCCH equal to j+1 is received, HARQ-ACK(j) may be the corresponding ACK/NACK/DTX response; otherwise HARQ-ACK(j) may be set to DTX.

The UE 102 may determine the number of elements for the subframe n of the DL association set in the serving cell (e.g., M) according to M=max(M_{primary},min(M_{secondary},M_{config})). M_{primary} is the number of elements for subframe n in the DL association K defined in Table (1) above for the primary cell TDD UL/DL configuration. M_{secondary} is the number of elements for subframe n in the DL association set K_{c} for the secondary cell. DL association set K_{c} contains values of kεK such that subframe n−k corresponds to a DL subframe or a special subframe for serving cell c. DL association set K is associated with subframe n. For the first option for TDD-FDD CA, DL association set K is defined in the DL subframe set for the FDD cell. For the second option for TDD-FDD CA, DL association set K is defined in the DL subframe set of a DL-reference UL/DL configuration.

If min(M_{secondary},M_{config})<M, then UE 102 may, for the secondary cell, set HARQ-ACK(j) to DTX for j=min(M_{secondary}, M_{config}) to M−1. If M_{primary}<M, then the UE 102 may, for the primary cell, set HARQ-ACK(j) to DTX for j=M_{primary} to M−1.

In carrier aggregation and PUCCH format 1b with channel selection, the PUCCH format 1b resources of the PCell are implicitly mapped based on the PDCCH, EPDCCH or Semi-Persistent Scheduling (SPS). Thus, it may be difficult to use M_{config} on a TDD PCell when the PCell is configured with UL/DL configuration 5. The PUCCH format 1b resources of the SCell may be semi-statically configured by higher layers. Therefore, the use of M_{config} on a FDD or TDD SCell will not cause any issue on the PUCCH resource allocation. The use of M_{config} can enable PUCCH format 1b with channel selection for TDD-FDD CA when the FDD cell has a DL association set with more than 4 subframes, and for TDD CA when the TDD SCell has UL/DL configuration 5.

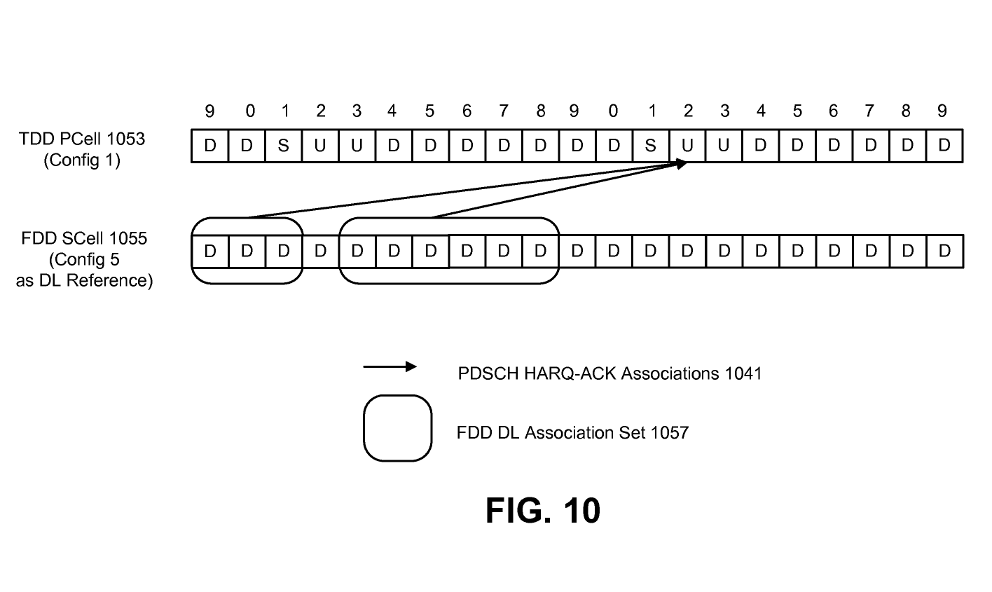

The systems and methods described herein define the maximum number of DLs can be assigned for PDSCH transmission for a given UE 102 without limiting the locations of the assigned subframes. Even in the second option for TDD-FDD CA discussed above, if UL/DL configuration 5 is configured as the DL-reference UL/DL configuration of a FDD SCell, and if M_{config} is less than or equal to 4 is configured for the FDD SCell, channel selection can also be used, as shown in FIG. 10. Thus, the described systems and methods provide flexibility for eNB 160 scheduling and enable reuse of PUCCH format 1b with channel selection tables of Release-10 and 11.

The described systems and methods may also reduce the HARQ-ACK bits on a SCell in TDD CA with different UL/DL configurations. This may result in utilizing a better channel selection table with enhanced performance. For example, according to current Release-11 and 12 specifications, if in a subframe with M_{primary}=2, and M_{secondary}=4, the channel selection table is based on M=max(M_{primary},M_{secondary}). However, if M_{config} equals to 2 or 3 is configured on a UE 102, the UE 102 is not expected to receive more than M_{config} bits. Therefore, the channel selection tables based on M=2 or 3 can be used, which provide better accuracy than M=4 tables.

The UE may send 708 the PDSCH HARQ-ACK information using PUCCH format 1b with channel selection. The UE 102 may send 708 the PDSCH HARQ-ACK information to the eNB 160. The PDSCH HARQ-ACK information may be sent 708 in a PUCCH format 1b report in subframe n.

FIG. 8 is a flow diagram illustrating another detailed configuration of a method 800 for performing carrier aggregation by a UE 102. The UE 102 may be located in a wireless communication network in which carrier aggregation may be performed with one or more FDD cells and one or more TDD cells. In one implementation, the wireless communication network may be an LTE network.

The UE 102 may communicate with an eNB 160 over a serving cell using either FDD or TDD duplexing. A serving cell may be a set of communication channels 119, 121. Multiple serving cells may be configured. During carrier aggregation (CA), more than one serving cell may be aggregated to a UE 102. In one configuration, a primary cell is a time-division duplexing (TDD) cell and a secondary cell is a FDD cell (e.g., TDD-FDD CA). In another configuration, every serving cell is a TDD cell (e.g., TDD CA), and a DL-reference UL/DL configuration of the PCell belongs to a TDD UL/DL configuration in the set of {0,1,2,3,4,6}. In yet another configuration, every serving cell is a TDD cell (e.g., TDD CA), and a DL-reference UL/DL configuration of the PCell belongs to a TDD UL/DL configuration 5.

The UE 102 may be configured 802 with PUCCH format 3. As mentioned before, CA provides more potential DL and UL subframes for data transmission. This may increase the peak throughput of a UE 102. However, because the DL and UL resources are shared with other UEs 102 in the same serving cell, it is unlikely that a single UE 102 is assigned with all DL resources. It is up to the eNB 160 to schedule the channel resources among different UEs 102.

In current PUCCH format 3 HARQ-ACK reporting, the ACK/NACK bits of each cell are multiplexed based on the cell index. In one configuration, a primary cell has a cell index of 0 and a secondary cell index number is ordered after the primary cell. The ACK/NACK of each cell is generated based on the subframe indexes in the DL association set and ACK/NACK of all subframes in a DL association set are reported even if they are not used. This brings unnecessary payload to PUCCH format 3 and limits the maximum number of cells that can be configured to a UE 102.

For the first option for TDD-FDD CA discussed above, a downlink association set for a FDD SCell may have five subframes if the DL-reference UL/DL configuration of the PCell is configuration 2 or configuration 4. Furthermore, a downlink association set for a FDD SCell may have 10 subframes if the DL-reference configuration of the PCell is configuration 5. If the maximum number of assigned subframes (e.g., M_{config}) is not configured, all subframes should be reported in PUCCH format 3. If M_{primary} or M_{secondary} is greater than 1, and two codewords are transmitted in a subframe, spatial bundling should be performed to generate one HARQ-ACK bit for a subframe.

In one case, if the DL-reference UL/DL configuration of the PCell is UL/DL configuration 2 or configuration 4, each FDD SCell may have 5 HARQ-ACK bits. Up to 4 cells can be configured to a UE 102 to keep the total number of HARQ-ACK bits below 20 bits.

In a second case, if the DL-reference UL/DL configuration of the PCell is UL/DL configuration 5, each FDD SCell may have 10 HARQ-ACK bits. Only 2 cells can be configured to a UE 102.

In a third case, if the DL-reference UL/DL configuration of the PCell is UL/DL configuration 3, the FDD SCell may report 6 bits in UL subframe 2. In this case, 3 cells can be configured to a UE 102. However, a different DL association set may be defined for UL/DL configuration 3 so that the maximum number of subframes in a set is less than or equal to 4, and up to 5 serving cells may be configured to a UE 102.

For the second option for TDD-FDD CA discussed above, if UL/DL configuration 5 is configured as the DL-reference UL/DL configuration, each FDD SCell may have 9 HARQ-ACK bits. In this case, only 2 cells can be aggregated to a UE 102.

The UE 102 may determine 804 a first parameter that defines a maximum number of elements with DL assignments for a subframe in the DL association set for a serving cell. This may be accomplished as described in connection with FIG. 2. In one configuration, the first parameter may be M_{config,c}. A UE 102 may be configured with the first parameter to enhance the HARQ-ACK multiplexing on PUCCH format 3.

The UE 102 may generate 806 PDSCH HARQ-ACK information for the serving cell. In one configuration, the UE 102 may generate 806 HARQ-ACK bits for a given cell c based on the minimum number between the number of elements with DL assignments for the subframe in the DL association set for the serving cell and the first parameter (e.g., M=min(M_{c},M_{config,c}). In other words, the UE 102 may generate 806 M=min(M_{c},M_{config,c}) HARQ-ACK bits for the given cell c.

In an uplink subframe, if the configured M_{config,c} is less than the corresponding M_{c} of the given serving cell (where M_{c} is the number of elements in the DL association set K_{c}), the UE 102 may follow the configured M_{config,c} for HARQ-ACK reporting of the given SCell, and the ACK/NACK bits of the reporting SCell will follow a DAI index instead of the subframe location. In other words, if M_{c}>M_{config,c}, M_{config,c} HARQ-ACK bits are generated 806 based on the detected DL DAI values.

If the configured M_{config,c} is greater than the corresponding M_{c} of the given serving cell, the UE 102 may follow M_{c} for HARQ-ACK reporting of the given SCell, and the ACK/NACK bits of the reporting SCell may follow the order of subframe location in the DL association set. In other words, if M_{c}<M_{config,c}, M_{c} HARQ-ACK bits are generated 806 based on the subframe ordering in the DL subframe set.

In some configurations, M_{config,c}=M_{config}. Furthermore, in some configurations, M_{config,c} is configured for each secondary cell for the UE 102. The HARQ-ACK bits of all serving cells may be multiplexed and reported on PUCCH format 3.

With the use of M_{config,c}, in an uplink subframe, if the configured M_{config,c} is less than the corresponding M_{c} of the given serving cell, the UE 102 should monitor the DL DAI filed in DCI format 1/1A/1B/1D/2/2A/2B/2C/2D to determine the ordering and multiplexing of the HARQ-ACK bits. If the received maximum DL DAI is less than the M_{config,c}, the remaining bits may be set to DTX. If PUCCH format 3 is configured, for a cell configured with M_{config,c}, only M_{config,c} bits are reported for the given cell instead of M_{c}.

The UE 102 should detect the value of the DAI in DCI format 1/1A/1B/1D/2/2A/2B/2C/2D, which denotes the accumulative number of PDCCH/EPDCCH(s) with assigned PDSCH transmission(s) up to the present subframe within subframe(s) n−k of each configured serving cell. In this case, kεK and K is the DL association set for the FDD cell, and may be updated from subframe to subframe. As described above V_{DAI,c}^{DL} is the value of the DAI in PDCCH/EPDCCH with DCI format 1/1A/1B/1D/2/2A/2B/2C/2D detected by the UE 102 according to Table (5) in subframe n−kₘ in serving cell c. kₘ is the smallest value in the DL association set K, where K is the DL association set for the FDD cell such that the UE 102 detects a DCI format 1/1A/1B/1D/2/2A/2B/2C/2D. The UE 102 should not expect to receive a DL DAI value that is greater than M_{config,c}.

If the serving cell is a secondary cell, for 0≦j≦M_{config}−1, if a PDSCH transmission with a corresponding PDCCH/EPDCCH and DAI value in the PDCCH/EPDCCH equal to j+1 is received, HARQ-ACK(j) may be the corresponding ACK/NACK/DTX response; otherwise HARQ-ACK(j) may be set to DTX. If the serving cell is a primary cell, and there is a PDSCH transmission on the primary cell without a corresponding PDCCH/EPDCCH detected within the subframe(s) n−k, where kεK of the primary cell, HARQ-ACK(0) may be the ACK/NACK/DTX response for the PDSCH transmission without a corresponding PDCCH/EPDCCH.

For 1≦j≦M_{config}−1, if a PDSCH transmission with a corresponding PDCCH/EPDCCH and DAI value in the PDCCH/EPDCCH equal to j or a PDCCH/EPDCCH indicating downlink SPS release and with DAI value in the PDCCH/EPDCCH equal to j is received, HARQ-ACK(j) may be the corresponding ACK/NACK/DTX response; otherwise HARQ-ACK(j) may be set to DTX.

If the serving cell is a primary cell, and there is no PDSCH transmission on the primary cell without a corresponding PDCCH/EPDCCH detected within the subframe(s) n−k, where kεK of the primary cell, for 0≦j≦M_{config}−1 and TDD UL/DL configuration of the primary cell belonging to {1,2,3,4,6}, if a PDSCH transmission with a corresponding PDCCH/EPDCCH and DAI value in the PDCCH/EPDCCH equal to j+1 or a PDCCH/EPDCCH indicating downlink SPS release and with DAI value in the PDCCH/EPDCCH equal to j+1 is received, HARQ-ACK(j) may be the corresponding ACK/NACK/DTX response; otherwise HARQ-ACK(j) may be set to DTX.

For 0≦j≦M_{config}−1 and the primary cell with TDD UL/DL configuration 0, if a PDSCH transmission with a corresponding PDCCH/EPDCCH or a PDCCH/EPDCCH indicating downlink SPS release is received, HARQ-ACK(0) may the corresponding ACK/NACK/DTX response; otherwise HARQ-ACK(j) may be set to DTX.

The use of M_{config,c} instead of the number of subframes in a DL association set (e.g., M_{c}) may reduce the HARQ-ACK payload of PUCCH format 3 reporting. This may increase the reliability of the HARQ-ACK feedback. By reducing ACK/NACK bits for a cell, more than 2 carriers can be supported even if the SCell is configured with configuration 5 as the DL-reference UL/DL configuration. For example, if M_{config,c} is configured, a TDD-FDD CA UE 102 may be configured with more carriers.

For the first option for TDD-FDD CA, if the DL-reference UL/DL configuration of the PCell is configuration 2 or configuration 4, each SCell may have 5 HARQ-ACK bits. If M_{config,c} is less than or equal to 4, up to 5 cells may be aggregated to a UE 102.

In TDD-FDD CA and/or TDD CA, if a UE 102 is configured with PUCCH format 3, the maximum number of configured cells of a UE 102 is determined by the M_{config,c} of the serving cells. In TDD-FDD CA, if the PCell is a TDD cell, and configuration 5 is used as the DL-reference UL/DL configuration of a FDD secondary cell, more than 2 serving cells may be configured for a UE 102. For example, if M_{config,c}=4, up to 5 cells may be configured to a UE 102. In TDD CA, if UL/DL configuration 5 is used as the DL-reference UL/DL configuration of a serving cell (PCell or SCell), more than 2 serving cells may be configured for a UE 102. For example, if M_{config,c}=4, up to 5 cells may be configured to a UE 102.

Even if the DL-reference UL/DL configuration of the SCell is UL/DL configuration 5, if the serving cell is configured with M_{config,c}, more cells can be aggregated to a UE 102. For instance, if the PCell is not UL/DL configuration 5, and SCell is configured with M_{config,c} less than or equal to 4, up to 5 cells can be aggregated. If the PCell is UL/DL configuration 5, and both PCell and SCell are applied with M_{config,c} less than or equal to 4, up to 5 cells may be configured to a UE 102. If M_{config,c} is 5, up to 4 cells may be configured to a UE 102. If M_{config,c} is 6, up to 3 cells may be configured to a UE 102.

The M_{config,c} may be applied on a FDD cell. The M_{config,c} may also be applied on a TDD cell. The M_{config,c} may be cell-specific. The M_{config,c} may be UE-specific and may be applied on all configured cells.

The M_{config,c} may also be applied in TDD CA with UL/DL configuration 5 to support more than 2 cells. If the serving cells are configured with M_{config,c} less than or equal to 4, up to 5 cells can be configured to a UE 102. If M_{config,c} is 5, up to 4 cells can be configured to a UE 102. If M_{config,c} is 6, up to 3 cells can be configured to a UE 102.

The M_{config,c} can also be applied in TDD CA or TDD-FDD CA to reduce the payload of PUCCH feedback. If the serving cell has a M_{c}=4, a smaller M_{config,c} may be configured so that the UE 102 only reports M_{config,c} bits instead of M_{c} bits for the given serving cell.

The UE may send 808 the PDSCH HARQ-ACK information using PUCCH format 3. The UE 102 may send 808 the PDSCH HARQ-ACK information to the eNB 160. The PDSCH HARQ-ACK information may be sent 808 in a PUCCH format 3 report in subframe n.

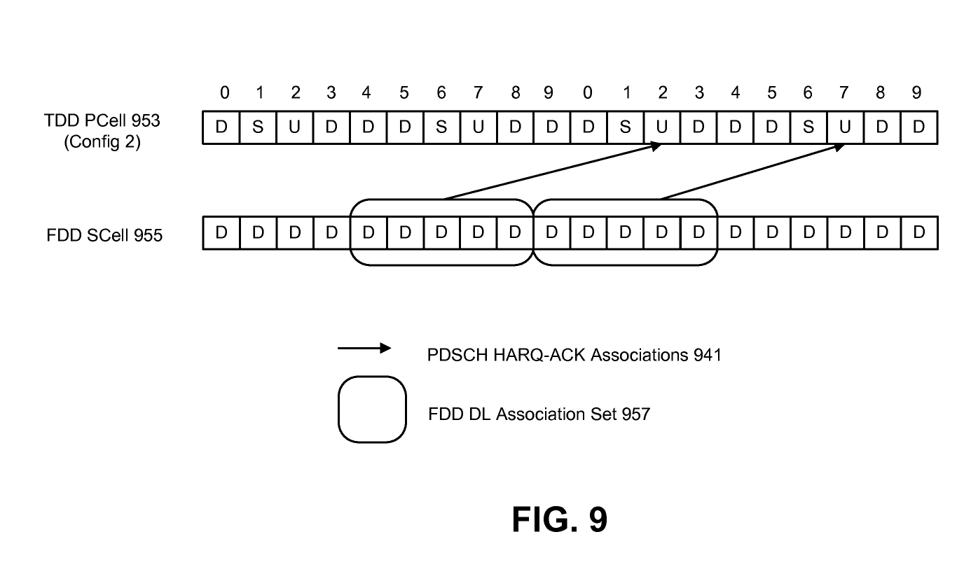

FIG. 9 illustrates one configuration of association timings of a TDD PCell 953 and a FDD SCell 955. In this example, the TDD PCell 953 and the FDD SCell 955 may be configured for TDD-FDD CA. FIG. 9 illustrates an example of the first option for TDD-FDD CA described above. In this first option, a FDD DL association set 957 is defined for the FDD SCell 955 so that the HARQ-ACK of FDD DL association sets 957 are reported to a subset or all uplink subframes of the TDD PCell 953.

The TDD PCell 953 may be configured with an UL/DL configuration 537, as described above in connection with FIG. 5. In this case, the TDD PCell 953 is configured with UL/DL configuration two 537c. However, other UL/DL configurations 537 may be used. For the FDD SCell 955, each of the downlink subframes 649 may be 1 ms, as described above in connection with FIG. 6.

The PDSCH HARQ-ACK associations 941 for the FDD DL association sets 957 are illustrated with the corresponding TDD PCell 953 subframe. In this example, the FDD DL association sets 957 have more than 4 subframes. The DL association set 957 of the FDD cell includes 5 DL subframes.

FIG. 10 illustrates another configuration of association timings of a TDD PCell 1053 and a FDD SCell 1055. In this example, the TDD PCell 1053 and the FDD SCell 1055 may be configured for TDD-FDD CA. FIG. 10 illustrates an example of the second option for TDD-FDD CA described above. In this second option for TDD-FDD CA, a DL-reference UL/DL configuration is configured by RRC signaling for the FDD SCell 1055.

The TDD PCell 1053 may be configured with an UL/DL configuration 537, as described above in connection with FIG. 5. In this case, the TDD PCell 1053 is configured with UL/DL configuration one 537b. For the FDD SCell 1055, each of the downlink subframes may be 1 ms, as described above in connection with FIG. 6. The FDD SCell 1055 is configured with UL/DL configuration five 537f as the DL-reference UL/DL configuration.

The PDSCH HARQ-ACK associations 1041 for the FDD DL association sets 1057 are illustrated with the corresponding TDD PCell 1053 subframe. In this example, the FDD DL association set 1057 has more than 4 subframes. In this case, the nine DL subframes are included in the FDD DL association set 1057.

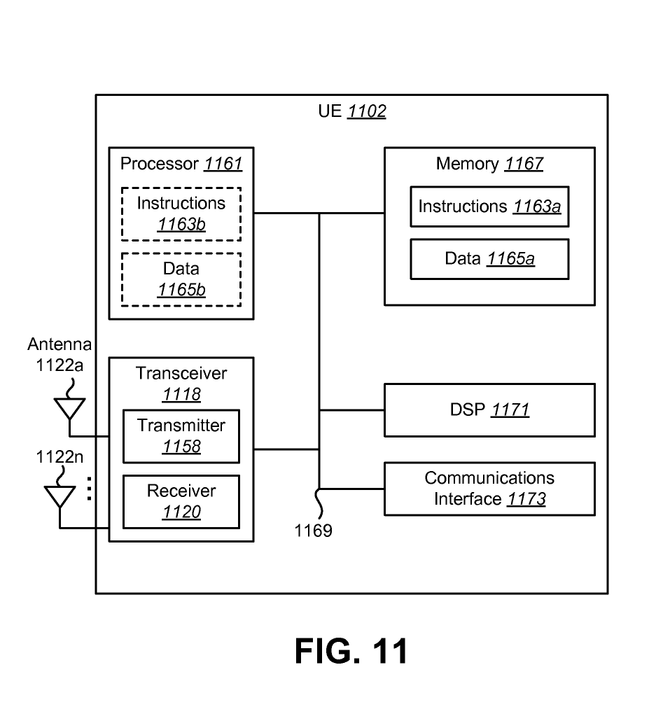

FIG. 11 illustrates various components that may be utilized in a UE 1102. The UE 1102 described in connection with FIG. 11 may be implemented in accordance with the UE 102 described in connection with FIG. 1. The UE 1102 includes a processor 1161 that controls operation of the UE 1102. The processor 1161 may also be referred to as a central processing unit (CPU). Memory 1167, which may include read-only memory (ROM), random access memory (RAM), a combination of the two or any type of device that may store information, provides instructions 1163a and data 1165a to the processor 1161. A portion of the memory 1167 may also include non-volatile random access memory (NVRAM). Instructions 1163b and data 1165b may also reside in the processor 1161. Instructions 1163b and/or data 1165b loaded into the processor 1161 may also include instructions 1163a and/or data 1165a from memory 1167 that were loaded for execution or processing by the processor 1161. The instructions 1163b may be executed by the processor 1161 to implement one or more of the methods 200, 700 and 800 described above.

The UE 1102 may also include a housing that contains one or more transmitters 1158 and one or more receivers 1120 to allow transmission and reception of data. The transmitter(s) 1158 and receiver(s) 1120 may be combined into one or more transceivers 1118. One or more antennas 1122a-n are attached to the housing and electrically coupled to the transceiver 1118.

The various components of the UE 1102 are coupled together by a bus system 1169, which may include a power bus, a control signal bus and a status signal bus, in addition to a data bus. However, for the sake of clarity, the various buses are illustrated in FIG. 11 as the bus system 1169. The UE 1102 may also include a digital signal processor (DSP) 1171 for use in processing signals. The UE 1102 may also include a communications interface 1173 that provides user access to the functions of the UE 1102. The UE 1102 illustrated in FIG. 11 is a functional block diagram rather than a listing of specific components.

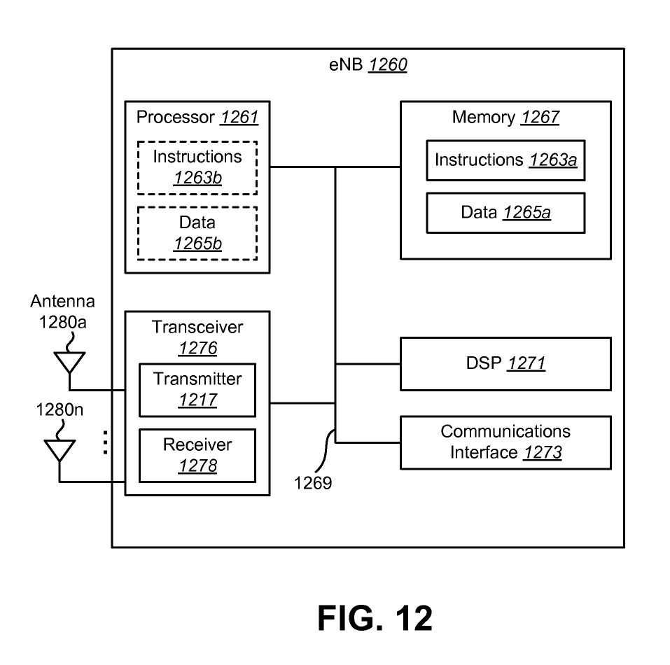

FIG. 12 illustrates various components that may be utilized in an eNB 1260. The eNB 1260 described in connection with FIG. 12 may be implemented in accordance with the eNB 160 described in connection with FIG. 1. The eNB 1260 includes a processor 1261 that controls operation of the eNB 1260. The processor 1261 may also be referred to as a central processing unit (CPU). Memory 1267, which may include read-only memory (ROM), random access memory (RAM), a combination of the two or any type of device that may store information, provides instructions 1263a and data 1265a to the processor 1261. A portion of the memory 1267 may also include non-volatile random access memory (NVRAM). Instructions 1263b and data 1265b may also reside in the processor 1261. Instructions 1263b and/or data 1265b loaded into the processor 1261 may also include instructions 1263a and/or data 1265a from memory 1267 that were loaded for execution or processing by the processor 1261. The instructions 1263b may be executed by the processor 1261 to implement the method 300 described above.

The eNB 1260 may also include a housing that contains one or more transmitters 1217 and one or more receivers 1278 to allow transmission and reception of data. The transmitter(s) 1217 and receiver(s) 1278 may be combined into one or more transceivers 1276. One or more antennas 1280a-n are attached to the housing and electrically coupled to the transceiver 1276.

The various components of the eNB 1260 are coupled together by a bus system 1269, which may include a power bus, a control signal bus and a status signal bus, in addition to a data bus. However, for the sake of clarity, the various buses are illustrated in FIG. 12 as the bus system 1269. The eNB 1260 may also include a digital signal processor (DSP) 1271 for use in processing signals. The eNB 1260 may also include a communications interface 1273 that provides user access to the functions of the eNB 1260. The eNB 1260 illustrated in FIG. 12 is a functional block diagram rather than a listing of specific components.

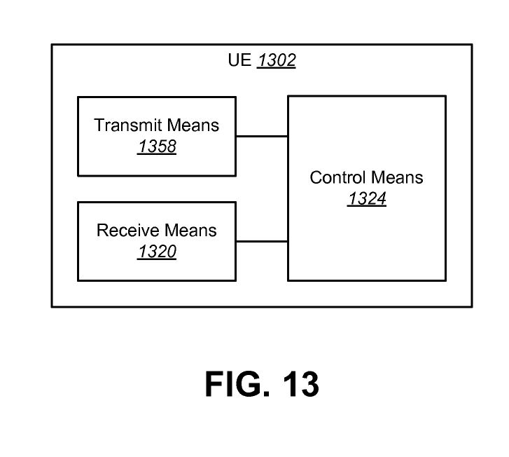

FIG. 13 is a block diagram illustrating one implementation of a UE 1302 in which systems and methods for performing carrier aggregation may be implemented. The UE 1302 includes transmit means 1358, receive means 1320 and control means 1324. The transmit means 1358, receive means 1320 and control means 1324 may be configured to perform one or more of the functions described in connection with FIG. 2, FIG. 7 and FIG. 8 above. FIG. 11 above illustrates one example of a concrete apparatus structure of FIG. 13. Other various structures may be implemented to realize one or more of the functions of FIG. 2, FIG. 7, FIG. 8 and FIG. 11. For example, a DSP may be realized by software.

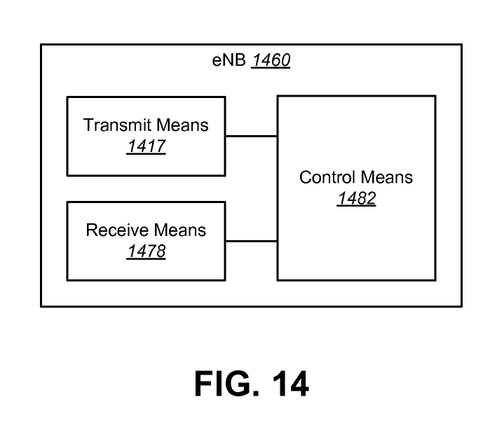

FIG. 14 is a block diagram illustrating one implementation of an eNB 1460 in which systems and methods for performing carrier aggregation may be implemented. The eNB 1460 includes transmit means 1417, receive means 1478 and control means 1482. The transmit means 1417, receive means 1478 and control means 1482 may be configured to perform one or more of the functions described in connection with FIG. 3 above. FIG. 12 above illustrates one example of a concrete apparatus structure of FIG. 11. Other various structures may be implemented to realize one or more of the functions of FIG. 3 and FIG. 12. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A user equipment (UE) for performing carrier aggregation, comprising:
a processor;
memory in electronic communication with the processor, wherein instructions stored in the memory are executable to:
determine a first parameter that defines a maximum number of elements with downlink (DL) assignments for a subframe in the DL association set for a serving cell, wherein multiple serving cells are configured;
determine physical downlink shared channel (PDSCH) hybrid automatic repeat request acknowledgement/negative acknowledgement (HARQ-ACK) information for the serving cell according to the first parameter; and
send the PDSCH HARQ-ACK information.

2. The UE of claim 1, wherein the instructions are further executable to receive the first parameter via higher layer signaling from an evolved Node B (eNB).

3. The UE of claim 1, wherein the first parameter is pre-defined as 4.

4. The UE of claim 3, wherein if the UE is configured with physical uplink control channel (PUCCH) format 1b with channel selection, the first parameter is assumed to be set.

5. The UE of claim 1, wherein determining the PDSCH HARQ-ACK information for the serving cell according to the first parameter comprises determining a number of HARQ-ACK bits for the serving cell according to the first parameter.

6. The UE of claim 1, wherein the instructions are further executable to:
configure the UE with physical uplink control channel (PUCCH) format 1b with channel selection; and
send the PDSCH HARQ-ACK information using PUCCH format 1b with channel selection, wherein the number of elements for the subframe of the DL association set in the serving cell equals
max(M_{primary},min(M_{secondary},M_{config})), wherein M_{primary} is the number of elements for the subframe of the DL association set in a primary cell, M_{secondary} is the number of elements for the subframe of the DL association set in a secondary cell and M_{config} is the first parameter.

7. The UE of claim 6, wherein the primary cell is a time-division duplexing (TDD) cell with a DL-reference uplink/downlink (UL/DL) configuration belonging to a TDD UL/DL configuration in the set of {0, 1, 2, 3, 4, 6}, and wherein the secondary cell is a frequency-division duplexing (FDD) cell.

8. The UE of claim 6, wherein every serving cell is a time-division duplexing (TDD) cell, a DL-reference uplink/downlink (UL/DL) configuration of the primary cell belongs to a TDD UL/DL configuration in the set of {0,1,2,3,4,6}, and a DL-reference UL/DL configuration of the secondary cell belongs to a TDD UL/DL configuration 5.

9. The UE of claim 1, wherein the instructions are further executable to:
configure the UE with physical uplink control channel (PUCCH) format 3;
generate the PDSCH HARQ-ACK information for the serving cell based on the minimum number between the number of elements with DL assignments for the subframe in the DL association set for the serving cell and the first parameter; and
send the PDSCH HARQ-ACK information using PUCCH format 3.

10. The UE of claim 9, wherein a primary cell is a time-division duplexing (TDD) cell and a secondary cell is a frequency-division duplexing (FDD) cell.

11. The UE of claim 9, wherein every serving cell is a time-division duplexing (TDD) cell, and wherein a DL-reference uplink/downlink (UL/DL) configuration of a primary cell belongs to a TDD UL/DL configuration in the set of {0,1,2,3,4,6}.

12. An evolved Node B (eNB) for performing carrier aggregation, comprising:
a processor;
memory in electronic communication with the processor, wherein instructions stored in the memory are executable to:
determine a first parameter that defines a maximum number of elements with downlink (DL) assignments for a subframe in the DL association set for a serving cell, wherein multiple serving cells are configured; and
receive physical downlink shared channel (PDSCH) hybrid automatic repeat request acknowledgement/negative acknowledgement (HARQ-ACK) information for the serving cell, wherein the PDSCH HARQ-ACK information is determined according to the first parameter.

13. The eNB of claim 12, wherein the instructions are further executable to send the first parameter via higher layer signaling to a user equipment (UE).

14. The eNB of claim 12, wherein the first parameter is pre-defined as 4.

15. The eNB of claim 14, wherein if a user equipment (UE) is configured with physical uplink control channel (PUCCH) format 1b with channel selection, the first parameter is assumed to be set.

16. The eNB of claim 12, wherein determining the PDSCH HARQ-ACK information for the serving cell comprises determining a number of HARQ-ACK bits for the serving cell according to the first parameter.

17. The eNB of claim 12, wherein the instructions are further executable to:
configure a user equipment (UE) with physical uplink control channel (PUCCH) format 1b with channel selection; and
receive the PDSCH HARQ-ACK information using PUCCH format 1b with channel selection, wherein the number of elements for the subframe of the DL association set in the serving cell equals
max(M_{primary},min(M_{secondary},M_{config})), wherein M_{primary} is the number of elements for the subframe of the DL association set in a primary cell, M_{secondary} is the number of elements for the subframe of the DL association set in a secondary cell and M_{config} is the first parameter.

18. The eNB of claim 17, wherein the primary cell is a time-division duplexing (TDD) cell with a DL-reference uplink/downlink (UL/DL) configuration belonging to a TDD UL/DL configuration in the set of {0,1,2,3,4,6}, and wherein the secondary cell is a frequency-division duplexing (FDD) cell.

19. The eNB of claim 17, wherein every serving cell is a time-division duplexing (TDD) cell, a DL-reference uplink/downlink (UL/DL) configuration of the primary cell belongs to a TDD UL/DL configuration in the set of {0,1,2,3,4,6}, and a DL-reference UL/DL configuration of the secondary cell belongs to a TDD UL/DL configuration 5.

20. The eNB of claim 12, wherein the instructions are further executable to:
configure a user equipment (UE) with physical uplink control channel (PUCCH) format 3; and
receive the PDSCH HARQ-ACK information using PUCCH format 3, wherein the PDSCH HARQ-ACK information is generated based on the minimum number between the number of elements with DL assignments for the subframe in the DL association set for the serving cell and the first parameter.

21. The eNB of claim 20, wherein a primary cell is a time-division duplexing (TDD) cell and a secondary cell is a frequency-division duplexing (FDD) cell.

22. The eNB of claim 20, wherein every serving cell is a time-division duplexing (TDD) cell, and wherein a DL-reference uplink/downlink (UL/DL) configuration of a primary cell belongs to a TDD UL/DL configuration in the set of {0,1,2,3,4,6}.

23. A method for performing carrier aggregation by a user equipment (UE), comprising:
determining a first parameter that defines a maximum number of elements with downlink (DL) assignments for a subframe in the DL association set for a serving cell, wherein multiple serving cells are configured;
determining physical downlink shared channel (PDSCH) hybrid automatic repeat request acknowledgement/negative acknowledgement (HARQ-ACK) information for the serving cell according to the first parameter; and
sending the PDSCH HARQ-ACK information.

24. The method of claim 23, wherein determining the PDSCH HARQ-ACK information for the serving cell according to the first parameter comprises determining a number of HARQ-ACK bits for the serving cell according to the first parameter.

25. The method of claim 23, further comprising:
configuring the UE with physical uplink control channel (PUCCH) format 1b with channel selection; and
sending the PDSCH HARQ-ACK information using PUCCH format 1b with channel selection, wherein the number of elements for the subframe of the DL association set in the serving cell equals
max(M_{primary},min(M_{secondary},M_{config})), wherein M_{primary} is the number of elements for the subframe of the DL association set in a primary cell, M_{secondary} is the number of elements for the subframe of the DL association set in a secondary cell and M_{config} is the first parameter.

26. The method of claim 23, further comprising:
configuring the UE with physical uplink control channel (PUCCH) format 3;
generating the PDSCH HARQ-ACK information for the serving cell based on the minimum number between the number of elements with DL assignments for the subframe in the DL association set for the serving cell and the first parameter; and
sending the PDSCH HARQ-ACK information using PUCCH format 3.

27. A method for performing carrier aggregation by an evolved Node B (eNB), comprising:
determining a first parameter that defines a maximum number of elements with downlink (DL) assignments for a subframe in the DL association set for a serving cell, wherein multiple serving cells are configured; and
receiving physical downlink shared channel (PDSCH) hybrid automatic repeat request acknowledgement/negative acknowledgement (HARQ-ACK) information for the serving cell, wherein the PDSCH HARQ-ACK information is determined according to the first parameter.

28. The method of claim 27, wherein determining the PDSCH HARQ-ACK information for the serving cell comprises determining a number of HARQ-ACK bits for the serving cell according to the first parameter.

29. The method of claim 27, further comprising:
configuring a user equipment (UE) with physical uplink control channel (PUCCH) format 1b with channel selection; and
receiving the PDSCH HARQ-ACK information using PUCCH format 1b with channel selection, wherein the number of elements for the subframe of the DL association set in the serving cell equals
max(M_{primary},min(M_{secondary},M_{config})), wherein M_{primary} is the number of elements for the subframe of the DL association set in a primary cell, M_{secondary} is the number of elements for the subframe of the DL association set in a secondary cell and M config is the first parameter.

30. The method of claim 27, further comprising:
configuring a user equipment (UE) with physical uplink control channel (PUCCH) format 3; and
receiving the PDSCH HARQ-ACK information using PUCCH format 3, wherein the PDSCH HARQ-ACK information is generated based on the minimum number between the number of elements with DL assignments for the subframe in the DL association set for the serving cell and the first parameter.
